(19) United States
(12) Patent Application Publication
(10) Pub. No.: US 2024/0027670 A1
(43) Pub. Date: Jan. 25, 2024

(54) Photonic Crystals and Methods for Fabricating the Same

(71) Applicant: DigiLens Inc., Sunnyvale, CA (US)

(72) Inventors: Jonathan David Waldern, Los Altos Hills, CA (US); Alastair John Grant, San Jose, CA (US); Milan Momcilo Popovich, Leicester (GB); Shibu Abraham, Sunnyvale, CA (US)

(73) Assignee: DigiLens Inc., Sunnyvale, CA (US)

(21) Appl. No.: 18/254,118

(22) PCT Filed: Nov. 22, 2021
(86) PCT No.: PCT/US21/72548

§ 371 Date: May 23, 2023

Related U.S. Application Data
(60) Provisional application No. 63/117,414, filed on Nov. 23, 2020.

(51) Int. Cl. G02B 5/32; G02B 27/42; G02B 17/08

(52) U.S. Cl. CPC G02B 5/32; G02B 27/4261; G02B 17/086; G02B 2027/0105

(57) ABSTRACT

Disclosed herein are various implementations display devices including phonic crystals. One embodiment includes a heads-up display including: a picture generation unit for projecting collimated light over a field of view; a first waveguide comprising an input grating for coupling the light from the picture generation unit into a total internal reflection path in the first waveguide and an output grating for providing beam expansion and light extraction from the first waveguide; a curved transparent substrate; and a mirror disposed with its reflecting surface facing a waveguide output surface of the first waveguide. The mirror may be configured to reflect light extracted from the first waveguide back through the first waveguide towards the curved transparent substrate. The first waveguide may be configured such that the curved transparent substrate reflects light extracted from the first waveguide towards an eyebox forming a virtual image viewable through the transparent curved substrate from the eyebox.

### CROSS-REFERENCED APPLICATIONS

This application claims priority to U.S. Provisional Application 63/117,414, entitled “Photonic Crystals Formed in HPDLC and Methods for Fabricating the Same” and filed on Nov. 23, 2020, the disclosure of which is included herein by reference in its entirety.

### FIELD OF THE INVENTION

The present invention generally relates to photonic crystals and, more specifically, to photonic crystals formed with holographic polymer dispersed liquid crystal.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (“TIR”).

Fabrication of waveguides can include the use of material systems that allow for the recording of holographic optical elements within the waveguides. One class of such material includes polymer dispersed liquid crystal (“PDLC”) mixtures, which are mixtures containing photopolymerizable monomers and liquid crystals. A further subclass of such mixtures includes holographic polymer dispersed liquid crystal (“HPDLC”) mixtures. Holographic optical elements, such as volume phase gratings, can be recorded in such a liquid mixture by illuminating the material with two mutually coherent laser beams. During the recording process, the monomers polymerize and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (“AR”) and virtual reality (“VR”), compact head-up displays (“HUDs”) and helmet-mounted displays or head-mounted displays (HMDs) for road transport, aviation, and military applications, and sensors for biometric and laser radar (“LIDAR”) applications.

### SUMMARY OF THE DISCLOSURE

Many embodiments are directed to a heads-up display including:
a picture generation unit for projecting collimated light over a field of view;
a first waveguide comprising an input grating for coupling the light from the picture generation unit into a total internal reflection path in the first waveguide and an output grating for providing beam expansion and light extraction from the first waveguide;
a curved transparent substrate; and
a mirror disposed with its reflecting surface facing a waveguide output surface of the first waveguide,
   The mirror may be configured to reflect light extracted from the first waveguide back through the first waveguide towards the curved transparent substrate. The first waveguide may be configured such that the curved transparent substrate reflects light extracted from the first waveguide towards an eyebox forming a virtual image viewable through the transparent curved substrate from the eyebox.

In various other embodiments, curved transparent substrate is a windshield.

In still various other embodiments, the light reflected from the mirror through the waveguide is off-Bragg with respect to the output grating.

In still various other embodiments, the first waveguide further includes a fold grating. The fold grating may be configured to provide a first beam expansion and the output grating may be configured to provide a second beam expansion orthogonal to the first beam expansion.

In still various other embodiments, the output grating provides a dual axis expansion grating configuration.

In still various other embodiments, the mirror has a surface curvature for compensating the aberrations produced by the curved transparent substrate.

In still various other embodiments, the mirror has polarization characteristics for compensating at least one of polarization rotation introduced by beam propagation in the waveguide and polarization rotation introduce by reflection at the substrate to provide a predefined polarization of light viewed through the eyebox.

In still various other embodiments, the mirror has a Fresnel form.

In still various other embodiments, the input grating and/or the output grating includes at least one selected from the group consisting of: a non-switchable grating, a switchable Bragg grating, a grating recorded in a mixture of liquid crystal and polymer, a surface relief grating, a deep surface relief grating, a deep grating formed by extracting liquid crystal from a grating recorded in a mixture of liquid crystal and polymer, a photonic crystal, a reflection grating, and a transmissive grating.

In still various other embodiments, the picture generation unit includes a light source, a microdisplay panel, and a projection lens.

In still various other embodiments, the picture generation unit includes a laser scanner.

In still various other embodiments, the picture generation unit includes a screen and a collimator. The screen may form an intermediate projected image.

In still various other embodiments, the screen is one selected from the group consisting of: a diffractive optical element, a multi-order diffractive optical element, a Fresnel optical surface, a diffractive Fresnel element, a substrate with spatially varying diffusion properties matched to numerical aperture of the collimator, a screen formed on a substrate with a curvature matching the focal surface of the collimator, and a screen formed on a substrate that can be vibrated to reduce speckle.

In still various other embodiments, the collimator is one selected from the group consisting of: a lens, a mirror, and a stack of diffractive optical elements operating at different wavelengths or configured to provide a first beam expansion orthogonal to a second beam expansion provided by the output grating.

In still various other embodiments, the heads-up display further includes a second waveguide, where the picture generation unit includes a light source configured to emit a first wavelength light and a second wavelength light, where the first wavelength light is coupled into the first waveguide and the second wavelength light is coupled into the second waveguide, and where the first waveguide and the second waveguide form a stack.

In still various other embodiments, the heads-up display further includes a halfwave film applied to a light extraction surface of the first waveguide.

In still various other embodiments, the heads-up display further includes a waveguide despeckler positioned along the optical path from the picture generation unit to the input grating of the waveguide.

In still various other embodiments, the heads-up display further includes a mechanically displaceable screen positioned along the optical path from the picture generation unit to the input grating of the waveguide.

In still various other embodiments, the heads-up display further includes a substrate supporting a switchable Bragg grating layer disposed in proximity to a reflecting surface of the waveguide, where the switchable Bragg grating has a spatially varying k-vector and clock angle for directing sunlight away from directions that would otherwise be diffracted or reflected into the eyebox.

In still various other embodiments, the switchable Bragg grating is at least one of configured to off-Bragg to light extracted from the waveguide or configured to have a preferred polarization different than that of light extracted from the waveguide.

In still various other embodiments, the mirror is a curved mirror.

In still various other embodiments, the first waveguide includes an input waveguide containing the input coupler and an output waveguide containing the output grating. The input waveguide and the output waveguide are positioned substantially overlapping, and wherein light from the input waveguide is coupled into the output waveguide through a plurality of prisms.

In still various other embodiments, a mirror surface of the mirror is aspheric.

In still various other embodiments, the mirror includes a negative meniscus lens with a surface on the rear side of a glass coated to form a curved mirror.

In still various other embodiments, the mirror includes a diffractive mirror.

In still various other embodiments, the diffractive mirror includes a reflective hologram formed on a flat surface.

In still various other embodiments, the diffractive mirror includes a reflective hologram formed on a curved surface.

In still various other embodiments, the diffractive mirror includes a reflective hologram made of separated layers each being sensitive to a specific wavelength band.

In still various other embodiments, the heads-up display further includes polarization modifying layers disposed between the output grating and the mirror.

In still various other embodiments, an air gap is disposed between the mirror and the output grating.

In still various other embodiments, the heads-up display further includes one or more optical filters disposed between the output grating and the mirror.

In still various other embodiments, the one or more optical filters fine tune the spectral characteristics of the light extracted from the first waveguide.

In still various other embodiments, the heads-up display further includes one or more filters disposed between the mirror and the output grating.

In still various other embodiments, the one or more filters block stray light from the first waveguide or block sunlight.

In still various other embodiments, the one or more filters includes louver arrays.

In still various other embodiments, the mirror includes an optical prescription including a universal base curvature.

In still various other embodiments, the optical prescription is dependent upon the curvature of the curved transparent substrate.

In still various other embodiments, the mirror includes a holographic mirror including a hologram substrate curvature and the optical prescription is provided by the hologram substrate curvature.

In still various other embodiments, the mirror is a portion of the first waveguide.

In still various other embodiments, the mirror includes coatings for rotating the polarization of the extracted light.

In still various other embodiments, the input grating and/or the output grating include an optical prescription for compensating for aberrations and distortions introduced by the mirror.

In still various other embodiments, the mirror includes an array of reflective elements.

In still various other embodiments, the mirror includes an array of elements configured to perform light field imaging.

In still various other embodiments, the mirror includes an array of diffractive optical elements.

In still various other embodiments, the mirror is mechanically and/or thermally deformable to provide variations of optical power.

In still various other embodiments, the mirror is configured to tilt to adjust for various eyebox locations.

Further, many embodiments are directed to a method of fabricating a device including the steps of:
providing a picture generation unit, a waveguide including an input coupler and an output grating, a curved transparent substrate, and a mirror;
coupling light into a waveguide;
extracting light from the waveguide;
using the mirror to reflect light through the waveguide onto the curved substrate, where the light incident on the curved transparent substrate is reflected towards an eyebox of a viewer.

In various other embodiments, the mirror has a surface curvature for compensating the aberrations produced by the curved transparent substrate.

In still various other embodiments, the mirror has polarization characteristics for compensating at least one of polarization rotation introduced by beam propagation in the waveguide and polarization rotation introduce by reflection at the curved transparent substrate to provide a predefined polarization of light viewed through the eyebox.

In still various other embodiments, the mirror has a Fresnel form.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 illustrates a cross sectional view of an example surface relief grating which may make up a photonic crystal in accordance with an embodiment of the invention.

FIG. 2 illustrates a cross section through a photonic crystal having a three-dimensional lattice with grating features separated by air spaces in accordance with an embodiment of the invention.

FIG. 3 conceptually illustrates a cross section of a waveguide having a reflective input grating and an output grating in accordance with an embodiment of the invention.

FIG. 4 conceptually illustrates a cross section of a waveguide having a transmission input grating and an output grating in accordance with various embodiments of the invention.

FIG. 5 conceptually illustrates a plan view of a waveguide display in accordance with an embodiment of the invention.

FIG. 6 conceptually illustrates a plan view of a waveguide providing two-dimensional beam expansion in accordance with an embodiment of the invention.

FIG. 7 conceptually illustrates a plan view of a waveguide providing beam expansion in two orthogonal dimensions using crossed gratings in accordance with an embodiment of the invention.

FIGS. 8A-8D conceptually illustrate a process for fabricating a deep SRG in accordance with various embodiments of the invention.

FIG. 9 conceptually illustrates a flow chart for a process for forming a surface relief grating from a HPDLC Bragg grating formed on a transparent substrate in accordance with an embodiment of the invention.

FIGS. 10A-10E conceptually illustrate a process for fabricating a hybrid surface relief Bragg grating in accordance with various embodiments of the invention.

FIG. 11 conceptually illustrates a method for forming a hybrid surface relief/Bragg grating from a HPDLC Bragg grating formed on a transparent substrate in accordance with an embodiment of the invention.

FIG. 12 is a graph showing P-polarized and S-polarized diffraction efficiency versus incidence angle for a 1-micrometer thickness surface relief grating.

FIG. 13 is a graph showing calculated P-polarized and S-polarized diffraction efficiency versus incidence angle for a 2-micrometers thickness deep surface relief grating.

FIG. 14 is a graph showing calculated P-polarized and S-polarized diffraction efficiency versus incidence angle for a 3-micrometer thickness.

FIGS. 15A-15B show angular and spectral diffraction efficiency characteristics for a reflection structure formed from an HPDLC in accordance with an embodiment of the invention.

FIGS. 16A-16B show the corresponding diffraction efficiency characteristics of a grating formed from a polymer of index 1.8 (refractive index modulation 0.4) for the same beam angles.

FIGS. 17A-17E illustrate the step in fabricating a reflective Bragg grating in accordance with an embodiment of the invention.

FIG. 18 conceptually illustrates a reflection grating having alternate layers of a first refractive index material and a second refractive index material in accordance with an embodiment of the invention.

FIG. 19 conceptually illustrates a reflection grating having alternate regions of a first refractive index material and a second refractive index material in accordance with an embodiment of the invention.

FIG. 20 conceptually illustrates ray propagation in a reflection grating 280 having alternate regions of a first refractive index material and a second refractive index material and substantially vertically extending regions of a third refractive index material in accordance with an embodiment of the invention.

FIG. 21 conceptually illustrates a mirror illumination apparatus for use in a waveguide display in accordance with an embodiment of the invention.

FIG. 22 conceptually illustrates a mirror illumination apparatus based on the apparatus of FIG. 21 which further includes a screen disposed at the second focal plane of the lens in accordance with an embodiment of the invention.

FIG. 23 conceptually illustrates an embodiment based on the embodiment of FIG. 22 in which the mirror is replaced by stacked RGB diffracting gratings in accordance with an embodiment of the invention.

FIGS. 24A-24B conceptually illustrate various views of a waveguide apparatus including a light pipe in accordance with an embodiment of the invention.

FIG. 25B shows a cross section view of the waveguide of FIG. 25A, illustrating ray paths in accordance with an embodiment of the invention.

FIG. 25C illustrates a design for a waveguide display implementing a mirror in accordance with an embodiment of the invention.

FIG. 26 conceptually illustrates a folded waveguide arrangement for reducing the overall grating footprint in accordance with an embodiment of the invention.

FIG. 27 conceptually illustrates a waveguide display using a deep SRG input grating according to the principles discussed above in accordance with an embodiment of the invention.

FIG. 28 conceptually illustrates a waveguide display using a reflective photonic crystal input grating in accordance with the principles discussed above and in accordance with an embodiment of the invention.

FIG. 29 schematically illustrates a waveguide display including a horizontal single axis expansion architecture in accordance with an embodiment of the invention.

FIGS. 30A-30B illustrate a schematic of a waveguide display with no fold grating in accordance with an embodiment of the invention.

FIGS. 30C-30D illustrates a modified version of the waveguide display described in connection with FIGS. 30A-30B in accordance with an embodiment of the invention.

FIG. 31 conceptually illustrates a waveguide display including an integrated dual axis (IDA) architecture in accordance with an embodiment of the invention.

FIGS. 32-33 conceptually illustrate various views of heads up display 400 with a waveguide illustrating potential unwanted sunlight in accordance with an embodiment of the invention.

FIGS. 34-35 schematically illustrate various views of heads up display with a waveguide integrating a sunlight blocking grating in accordance with an embodiment of the invention.

FIG. 36 shows a multi-grating structure in accordance with an embodiment of the invention.

FIG. 37 conceptually illustrates a waveguide display including an integrated dual axis (IDA) architecture in accordance with an embodiment of the invention.

FIGS. 38-39 schematically illustrate a cross sectional view of the waveguide display of FIG. 37 illustrating two example operational states.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings are not drawn to scale unless stated otherwise.

Some embodiments of the disclosed technology include a waveguide supporting at least one photonic crystal. A photonic crystal can be referred to as a periodic optical nanostructure that affects the motion of photons. Photonic crystals can be fabricated for one, two, or three dimensions. An example of a one-dimensional photonic crystal is a grating structure formed from alternating layers of high refractive index and low refractive index materials. Such gratings are commonly referred to as Bragg or volume gratings. In many cases, the regions of low refractive index in the photonic crystals are provided by air, resulting in a structure similar to surface relief gratings (SRGs).

In some embodiments, the grating structures may be integrated into a waveguide which may be used in a heads-up display. The waveguide may input and output light through the grating structures. The waveguide may output light onto a curved transparent substrate such as a windscreen of an automobile. The heads-up display may further include a mirror disposed with its reflecting surface facing the waveguide output surface, where the mirror is configured to reflect light extracted from the waveguide back through the waveguide towards the curved transparent substrate. Advantageously, the mirror may reduce aberrations introduced by the curved transparent substrate.

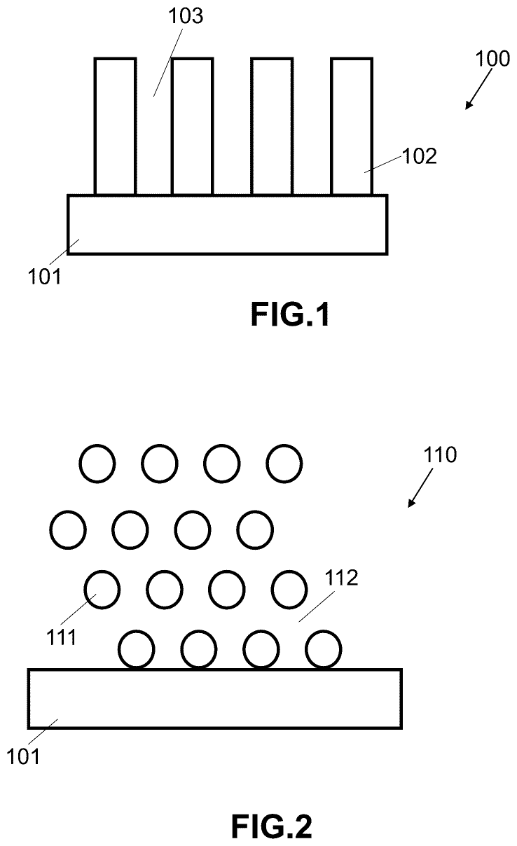

FIG. 1 illustrates a cross sectional view of an example surface relief grating 100 which may make up a photonic crystal in accordance with an embodiment of the invention. The grating 100 includes an optical substrate 101 supporting grating elements 102 separated by air gaps 103. A two-dimensional photonic crystal can be formed by a two-dimensional array of elements of a first refractive index immersed in a material of a second refractive index. Two-dimensional photonic crystals can be fabricated by photolithography, or by drilling holes or cavities in a suitable substrate. In many cases, two-dimensional photonic crystals can be any of the five 2D Bravais lattices. Fabrication methods for three-dimensional photonic crystals can include drilling through a volume of material under different angles, stacking multiple 2D layers on top of each other, and direct laser writing. Another approach includes forming a matrix of spheres or instigating self-assembly of spheres in a matrix and dissolving either the material contained within the spheres or the material within which the spheres are immersed. In many cases, three-dimensional photonic crystals can be any of the fourteen 3D Bravais lattices.

FIG. 2 illustrates a cross section through a photonic crystal 110 having a three-dimensional lattice with grating features 111 separated by air spaces 112 in accordance with an embodiment of the invention. In some embodiments, the lattice elements can include air regions surround by an optical material. In several embodiments, the lattice can be one of the Bravais lattices. Typically, photonic crystals have periodicity of around half the wavelength of the light to be diffracted. In many cases, the photonic crystal includes repeating regions of high and low dielectric constant. In some cases, the low dielectric can be provided by air. As can readily be appreciated, different fabrication techniques photonic crystals can result in different structures, the dimensionality of which can depend on the direction or directions in which there is a refractive index distribution.

In many of the embodiments of the invention to be described below, a photonic crystal including a grating structure immersed at least partially in air can be formed from a mixture of liquid crystal (LC) and monomer materials using a phase separation process taking place under holographic exposure. After the exposure process is complete, liquid crystal can be removed from the structure. This type of grating structure may be referred to as an evacuated Bragg grating (EBG) which is described in detail in U.S. Pat. App. Pub. No. 2021/0063634, entitled “Evacuating Bragg gratings and methods of manufacturing” and filed on Aug. 28, 2020 which is hereby incorporated by reference in its entirety.

In many embodiments, the grating structure can be refilled with a different material, such as but not limited to an LC. The refilled LC can have the same or different index and/or other properties. In some embodiments, the grating structure can be partially backfilled to provide a hybrid surface relief and volume grating structure. In several embodiments, the grating structure can be refilled with an organic or inorganic material with a high refractive index. These refilled grating structure may be referred to as hybrid gratings and are described in detail in U.S. Pat. App. Pub. No. 2021/0063634, entitled “Evacuating Bragg gratings and methods of manufacturing” and filed on Aug. 28, 2020 which is hereby incorporated by reference in its entirety.

In various embodiments, the grating can have material properties varying spatially. In a number of embodiments, the refilled portions have varying depths. The backfilling can be performed using a variety of different processes, including but not limited to diffusion processes and phase separation processes. In many embodiments, the grating structure can be backfilled with chemical components that are phase separated under a laser exposure process. In many embodiments, backfilling can be carried out in the presence of thermal, mechanical, chemical, or electromagnetic stimuli for influencing annealing and/or alignment of the grating structure. The grating structures described above can result in a diffractive surface. In some embodiments, the diffractive surface can be a metasurface. A metasurface can be referred to as a surface structure with sub wavelength thickness containing subwavelength scale diffracting patterns. In some embodiments, a metasurface may include diffracting feature sizes and spacing that are in the nanometer regions. For example, feature spacings in metasurfaces designed for the visible band may be as small as tens of nanometers in at least one direction. For comparison, conventional diffractive structures for use in the visible band may have features spaces of typically hundreds of nanometers.

Photonic crystals in accordance with various embodiments of the invention can be implemented for various purposes, which can depend on the specific application. In many embodiments, a photonic crystal can be implemented for use in a single axis or in dual expansion waveguides. In some embodiments, photonic crystals can be used to provide beam expansion gratings. In several embodiments, a photonic crystal provides an input grating. In various embodiments, a photonic crystal provides an output grating. In a number of embodiments, photonic crystals can be used to diffract more than one primary color. In some embodiments, waveguides incorporating photonic crystals can be arrange in stacks of waveguides, each having a grating prescription for diffracting a unique spectral bandwidth.

As will be discussed in the following paragraphs, a photonic crystal formed by liquid crystal extraction offers potential benefits in terms of improving the angular bandwidth of a waveguide. Such architectures can also be used to control the polarization characteristics of waveguided light. The various embodiments to be discussed can be applied in various application, including but not limited to HUDs for automotive applications, near eye displays, and other waveguide display applications.

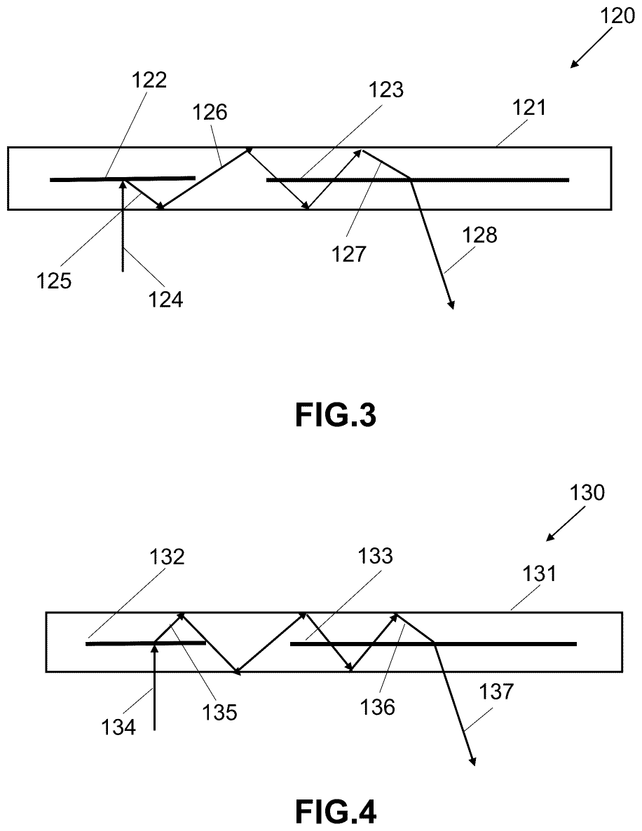

Referring back to the drawings, photonic crystal architectures and related methods of manufacturing in accordance with various embodiments of the invention are illustrated. FIG. 3 conceptually illustrates a cross section of a waveguide having a reflective input grating and an output grating in accordance with an embodiment of the invention. As shown, the apparatus 120 includes a waveguide 121 supporting a reflection input grating 122 and an output grating 123. In the illustrative embodiment, input light 124 from a light source (not shown), such as but not limited to a picture generation unit (PGU), is coupled into the waveguide 121 by the input grating 122 and propagates along a total internal reflection path indicated by the rays 125-127 before being extracted by the output grating 123.

FIG. 4 conceptually illustrates a cross section of a waveguide having a transmission input grating and an output grating in accordance with various embodiments of the invention. As shown, the apparatus 130 includes a waveguide 131 supporting a transmissive input grating 132 and an output grating 133. In the illustrative embodiment, input light 134 from a light source is coupled into the waveguide by the input grating 132 and propagates along a total internal reflection path indicated by the rays 135, 136 before being extracted by the output grating 133 as outputted light 137.

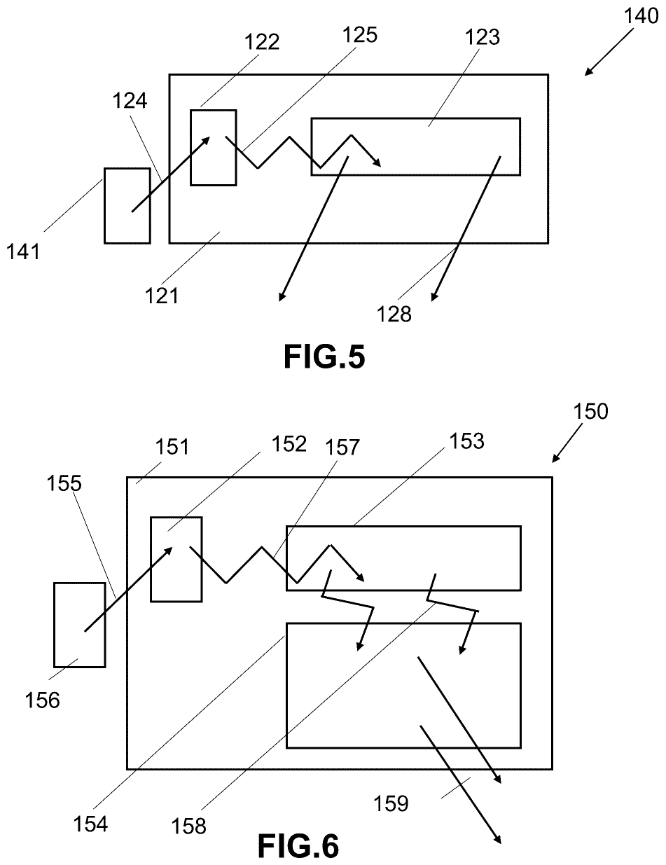

In any of the embodiments described above and throughout this disclosure, the output grating can provide one-dimensional beam expansion. In some embodiments, the waveguide further supports a fold grating. In further embodiments, the fold grating and the output grating together provide two-dimensional beam expansion with the fold grating providing expansion in a first direction and the output grating 133 providing expansion in a second direction orthogonal to the first direction. FIG. 5 conceptually illustrates a plan view of a waveguide display 140 in accordance with an embodiment of the invention. The waveguide display shares many features with the waveguide display 120 of FIG. 3 which description is applicable to the waveguide display 140 of FIG. 5. The waveguide display 140 includes a PGU 141 as the light source. As shown, the output grating 123 may provide one-dimensional beam expansion.

FIG. 6 conceptually illustrates a plan view of a waveguide 151 providing two-dimensional beam expansion in accordance with an embodiment of the invention. As shown, the apparatus 150 includes a waveguide 151 supporting a reflective input grating 152, a fold grating 153 that provides a first direction beam expansion, and an output grating 154. Input light 155 from a PGU 156 may be coupled into the waveguide 151 by the input grating 152 and propagates along total internal reflection paths indicated by the rays 157, 158 before being extracted by the output grating 154, which provides a second beam expansion orthogonal to the first beam expansion. The light may be extracted out of the waveguide 151 by the output grating 154 as extracted light 159.

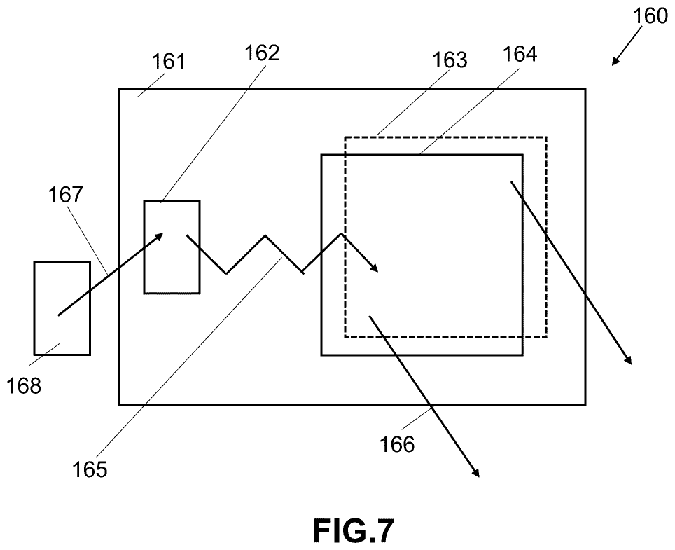

Waveguides in accordance with various embodiments of the invention can include crossed gratings for providing the capabilities of both the fold and output gratings as described above—e.g., providing two-dimensional beam expansion. FIG. 7 conceptually illustrates a plan view of a waveguide providing beam expansion in two orthogonal dimensions using crossed gratings in accordance with an embodiment of the invention. As shown, the waveguide apparatus 160 includes a waveguide 161 supporting an input grating 162 and a pair of overlapping or multiplexed fold gratings 163, 164. In the illustrative embodiment, the total internal reflection path from the input grating 162 to the fold gratings 163, 164 and the pupil-expanded light extracted from the waveguide 161 by the overlapping fold gratings 163, 164 are represented by the rays 165, 166. Input light 167 can be provided by a PGU 168.

Although FIGS. 3-7 show specific waveguide architectures, various waveguide configurations can be implemented as appropriate depending on the specific requirements of a given application. For example, in several embodiments, at least one of the gratings may be a photonic crystal formed using a liquid crystal extraction process. In many embodiments, a photonic crystal formed by liquid crystal extraction provides a deep surface relief grating. Deep SRGs can be implemented for various applications. In some embodiments, the deep SRG provides a high S-polarization diffraction response. Deep SRGs can, as will be discussed below, provide a range of polarization response characteristics depending on the thickness of the grating prescription and, in particular, the grating depth. Deep SRGs can also be used in conjunction with convention Bragg gratings to enhance the color, uniformity and other properties of waveguide displays. Deep surface relief gratings, photonic crystals, waveguide architectures, and related methods of manufacturing of such components are discussed below in further detail.

In many embodiments, a deep SRG formed using a liquid crystal extraction process can typically have a thickness in the range 1-3 micrometers with a Bragg fringe spacing of 0.35 micrometer to 0.80 micrometer. In some embodiments, the condition for a deep SRG is characterized by a high grating depth to fringe spacing ratio. In several embodiments, the condition for the formation of a deep SRG is that the grating depth can be approximately twice the grating period. Such SRGs can exhibit the properties of Bragg gratings. Modelling such SRGs using the Kogelnik theory can give reasonably accurate estimates of diffraction efficiency, avoiding the need for more advanced modelling which typically entails the numerical solution of Maxwell's equations. The grating depths that can be achieved using liquid crystal removal from HPDLC gratings greatly surpass those possible using conventional nanoimprint lithographic methods, which do not achieve the condition for a deep SRG (typically providing only 250-300 nm depth for grating periods 350-460 nm). (Pekka Äyräs, Pasi Saarikko, Tapani Levola, “Exit pupil expander with a large field of view based on diffractive optics,” Journal of the SID 17/8, (2009), pp 659-664). Deep SRGs can be fabricated in glassy monomeric azobenzene materials using laser holographic exposure. Deep SRGs can also be recorded in a holographic photopolymer using two linearly orthogonally polarized laser beams. The recording of deep SRGs may not be limited to any particular recording material, exposure setup, or beam polarization configuration. The grating regions may contain removable material such as liquid crystal.

As described above, SRGs can exhibit properties similar to that of Bragg gratings. The diffraction properties of dielectric surface-relief gratings can be investigated by solving Maxwell's equations numerically. The diffraction efficiency of a grating with a groove depth about twice as deep as the grating period was found to be comparable with the efficiency of a volume phase grating. Dielectric surface-relief gratings interferometrically recorded in photoresist can possess a high diffraction efficiency of up to 94% (throughput efficiency 85%).

Various embodiments of the invention provide for methods of fabricating surface relief gratings that can offer very significant advantages over nanoimprint lithographic process particle for slanted gratings. Bragg gratings of any complexity can be made using interference or master and contact copy replication. In embodiments utilizing an LC and monomer mixture, the LC can be removed after formation of the Bragg grating, forming an SRG or deep SRG. This may be referred to as an evacuated Bragg grating (EBG). In some embodiments, after removing the LC, the SRG can be backfilled with a material with different properties to the original LC. This allows for the formation of a Bragg grating with modulation properties that are not limited by the grating chemistry needed for grating formation. In some embodiments, the SRG or deep SRG can be partially backfilled with another LC to provide a hybrid SRG/Bragg grating. Alternatively, in some embodiments, the refill step can be avoided by removing just a portion of the LC from the LC rich regions of the HPDLC to provide a hybrid SRG/Bragg grating. The refill approach has the advantage that a different material or different LC can be used to form the hybrid grating. The materials can be deposited using a variety of different processes, including but not limited to inkjet processes.

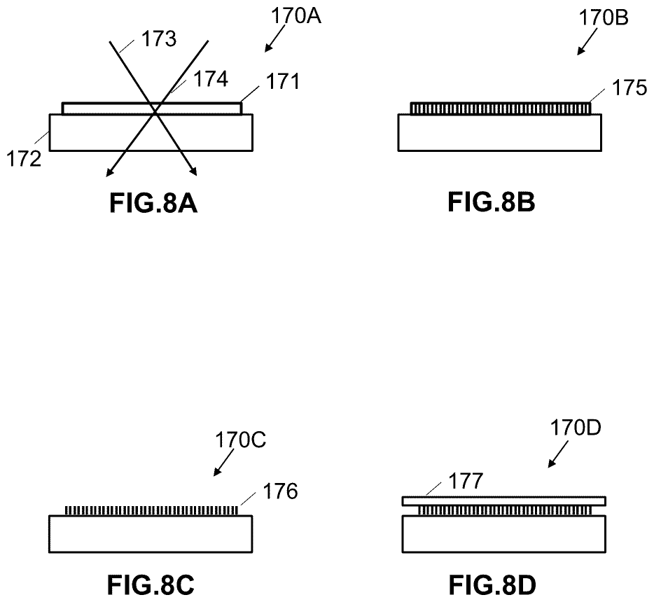

FIGS. 8A-8D conceptually illustrate a process for fabricating a deep SRG in accordance with various embodiments of the invention. FIG. 8A conceptually illustrates a step 170A in which a mixture 171 of monomer and liquid crystal are deposited on a transparent substrate 172 is subsequently exposed to holographic exposure beams 173, 174. FIG. 8B conceptually illustrates a step 170B in which an HPDLC Bragg grating 175 is formed from exposing the mixture 171. FIG. 8C conceptually illustrates a step 170C in which liquid crystal is removed from the HPDLC Bragg grating 175 to form a surface relief grating 176. FIG. 8D conceptually illustrates a step 170D in which the surface relief grating 176 is covered with a protective layer 177. These steps are described with greater detail in U.S. Pat. App. Pub. No. 2021/0063634, entitled “Evacuating Bragg gratings and methods of manufacturing” and filed Aug. 28, 2020, which is hereby incorporated by reference in its entirety for all purposes.

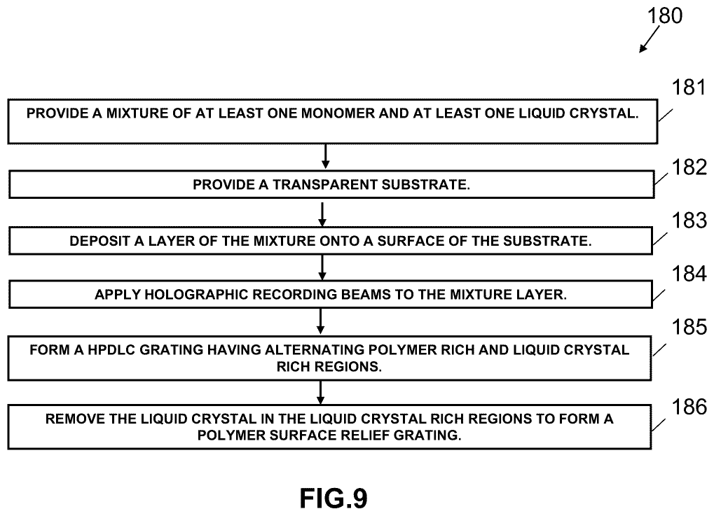

FIG. 9 conceptually illustrates a flow chart for a process for forming a surface relief grating from a HPDLC Bragg grating formed on a transparent substrate in accordance with an embodiment of the invention. As shown, the method 180 of forming a surface relief grating is provided. Referring to the flow diagram, method 180 includes providing (181) a mixture of at least one monomer and at least one liquid crystal. The method 180 further includes providing (182) a transparent substrate. The method 180 further includes depositing 183 a layer of the mixture onto a surface of the substrate. The mixture may include at least one monomer and at least one liquid crystal. The method 180 further includes applying (184) holographic recording beams to the mixture layer on the substrate. After exposure, a HPDLC grating having alternating polymer rich and liquid crystal rich regions can be formed (185). The method further includes at least partially removing (186) the liquid crystal in the liquid crystal rich regions to form a polymer surface relief grating. A hybrid grating may be formed by only partially removing the liquid crystal in the liquid crystal rich regions. As shown in FIGS. 8A-8D, the formed surface relief grating can optionally be covered with a protective layer. Further, as discussed above, a material may be backfilled into the regions where the liquid crystal is absent.

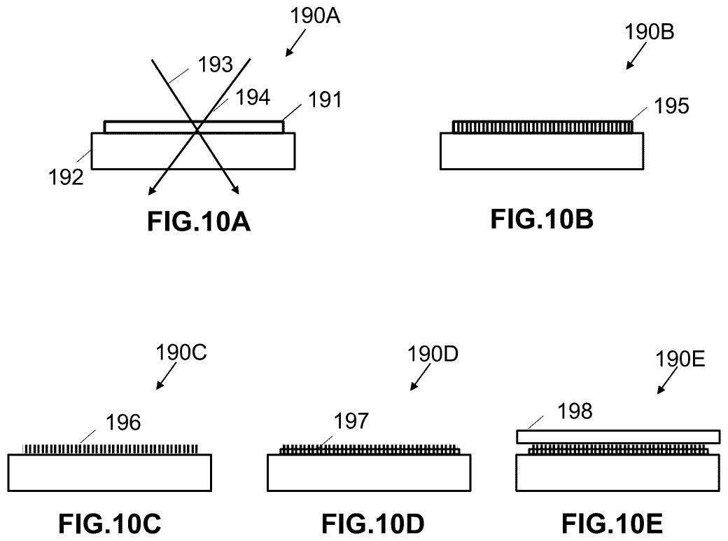

Many embodiments of the invention provide for methods for fabricating a hybrid surface relief/Bragg grating. FIGS. 10A-10E conceptually illustrate a process for fabricating a hybrid surface relief Bragg grating in accordance with various embodiments of the invention. FIG. 10A conceptually illustrates a step 190A in which a mixture 191 of monomer and liquid crystal is deposited on a transparent substrate 192 and is exposed with holographic exposure beams 193, 194. FIG. 10B conceptually illustrates a step 190B in which a HPDLC Bragg grating 195 is formed from the mixture 191 previously exposed to the holographic exposure beams 193, 194. FIG. 10C conceptually illustrates a step 190C in which liquid crystal is removed from the HPDLC Bragg grating 195 to form a surface relief grating 196. FIG. 10D conceptually illustrates a step 190D in which the surface relief grating 196 is at least partially refilled with a material in order to form a hybrid surface relief/Bragg grating 197. As described previously, the material may be another liquid crystal with different properties of the original liquid crystal. FIG. 10E conceptually illustrates a step 190E in which the hybrid surface relief Bragg grating 197 is covered with a protective layer 198.

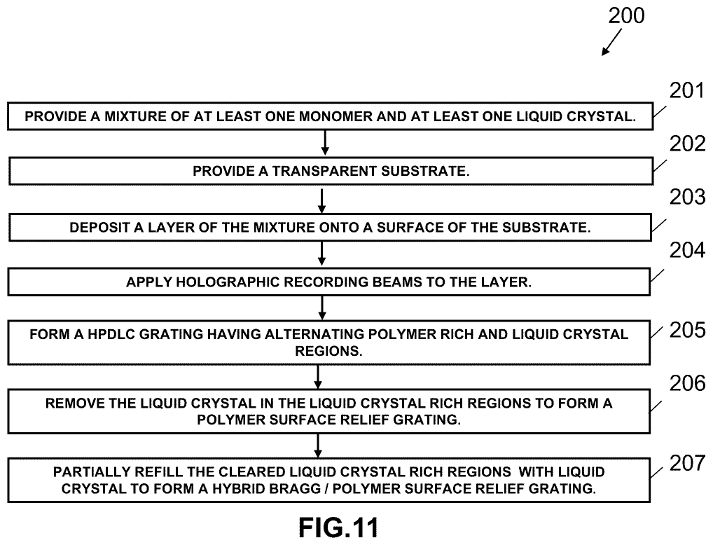

FIG. 11 conceptually illustrates a method for forming a hybrid surface relief/Bragg grating from a HPDLC Bragg grating formed on a transparent substrate in accordance with an embodiment of the invention. Referring to the flow diagram, method 200 includes providing (201) a mixture of at least one monomer and at least one liquid crystal. The method 200 may further include providing (202) a transparent substrate. The method further includes depositing (203) a layer of the mixture onto a surface of the transparent substrate. The method 200 may further include applying (204) holographic recording beams to the mixture layer. The holographic recording beams may form (205) an HPDLC grating having alternating polymer rich and liquid crystal rich regions. The method 200 may further include at least partially removing (206) the liquid crystal in the liquid crystal in the liquid crystal rich regions to form a polymer surface relief grating. The void formed in the liquid crystal rich regions can be partially refilled (207) with a material such as liquid crystal to form a hybrid surface relief/Bragg grating. As shown in FIGS. 10A-10E, the formed surface relief grating can optionally be covered with a protectively layer.

Although FIGS. 8A-11 show specific processes for forming SRGs and hybrid SRG/Bragg gratings, many different methods and alterations can be implemented as appropriate depending on the specific requirements of the given application. For example, many embodiments utilize another grating as a protective layer.

Hybrid SRG/Bragg gratings with shallow SRG structures can lead to low SRG diffraction efficiencies. The method disclosed in the present application allows more effective SRG structures to be formed by optimizing the depth of the liquid crystal in the liquid crystal rich regions such that the SRG has a high depth to grating pitch ratio while allowing the Bragg grating to be sufficiently thick for efficient diffraction. In many embodiments, the Bragg grating component of the hybrid grating can have a thickness in the range 1-3 micrometers. In some embodiments, the SRG component of the hybrid grating can have a thickness in the range 0.25-3 micrometers. The initial HPDLC grating would have a thickness of equal to the sum of the final SRG and Bragg grating components. As can readily be appreciated, the thickness ratio of the two grating components can depend on the waveguide application.

In many embodiments, the refill depth of the liquid crystal regions of the grating can be varied across the grating to provide spatially varying relative SRG/Bragg grating strengths. In some embodiments, as an alternative to liquid crystal removal and refill, the liquid crystal in the liquid crystal rich grating regions can be totally or partially removed. In several embodiments, the liquid crystal used to refill or partially refill the liquid crystal-cleared regions can have a different chemical composition to the liquid crystal used to form the HPDLC grating. In a number of embodiments, a first liquid crystal with phase separation properties compatible with the monomer can be specified to provide a HPDLC grating with optimal modulation and grating definitions while a second refill liquid crystal can be specified to provide desired index modulation properties in the final hybrid grating. In many embodiments, the Bragg portion of the hybrid grating can be switchable with electrodes applied to surfaces of the substrate and the cover layer. In some embodiments, the refill liquid crystals can contain additives for improving switching voltage, switching time, polarization, transparency, and/or other parameters. A hybrid grating formed using a refill process would have the further advantages that the LC would form a continuum (rather than an assembly of LC droplets), thereby reducing haze.

In many embodiments, a deep SRG can control polarization in a waveguide. Shallower SBGs are normally P-polarization selective, leading to a 50% efficiency loss with unpolarized light sources (containing both S and P polarized light) such as OLEDs and LEDs. Hence, combining S-polarization diffracting and P-polarization diffracting gratings can provide a theoretical 2× improvement over waveguides using P-diffracting gratings only. In some embodiments, an S-polarization diffracting grating can be provided by a Bragg grating formed in a conventional holographic photopolymer. In some embodiments, an S-polarization diffracting grating can be provided by a Bragg grating formed in a HPDLC with birefringence altered using an alignment layer or other process for realigning the liquid crystal directors. In some embodiments, an S-polarization diffraction grating can be formed using liquid crystals, monomers, and other additives that naturally organize into S-diffracting gratings under phase separation. In many embodiments, an S-polarization diffracting grating can be provided by a surface relief grating (SRG). Using the processes described above, a deep SRG exhibiting high S-diffraction efficiency (up to 99%) and low P-diffraction efficiency can be formed by removing the liquid crystal from a SBG formed from holographic phase separation of a liquid crystal and monomer mixture.

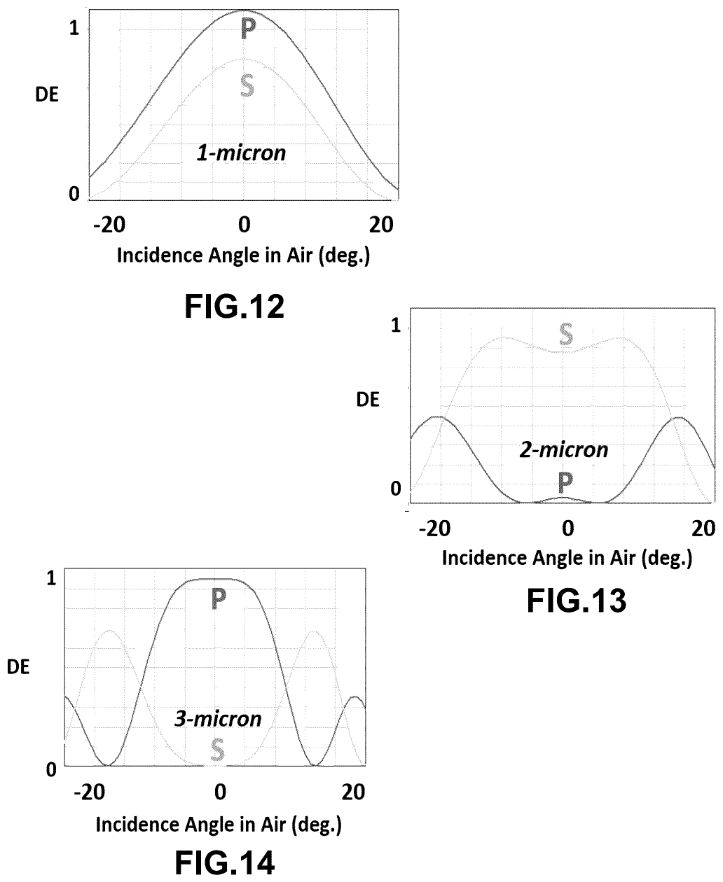

Deep SRGs can also provide other polarization response characteristics. Deep surface relief gratings having both S and P sensitivity with S being dominant can be formed and implemented. In many embodiments, the thickness of the SRG can be adjusted to provide a variety of S and P diffraction characteristics. In some embodiments, diffraction efficiency can be high for P polarization across a spectral bandwidth and angular bandwidth and low for S polarization across the same spectral bandwidth and angular bandwidth. In some embodiments, diffraction efficiency can be high for S across the spectral bandwidth and angular bandwidth and low for P across the same spectral bandwidth and angular bandwidth. In some embodiments, high efficiency for both S and P polarized light can be provided. A theoretical analysis of a SRG of refractive index 1.6 immersed in air (hence providing an average grating index of 1.3) of period 0.48 micrometer, with a 0 degree incidence angle and 45 degree diffracted angle for a wavelength of 0.532 micrometer is shown in FIGS. 12-14. FIG. 12 is a graph showing P-polarized and S-polarized diffraction efficiency versus incidence angle for a 1-micrometer thickness surface relief grating, demonstrating that in this case high S diffraction efficiency and P diffraction efficiency may be achieved. FIG. 13 is a graph showing calculated P-polarized and S-polarized diffraction efficiency versus incidence angle for a 2-micrometers thickness deep surface relief grating, demonstrating that in this case the S-polarization response is dominant over most of the angular range of the grating. Thus, at 2-micrometers thickness a high S-polarization response may be achieved with a low P-polarization response. FIG. 14 is a graph showing calculated P-polarized and S-polarized diffraction efficiency versus incidence angle for a 3-micrometer thickness, demonstrating that in this case the P-polarization response is dominant over a substantial portion of the angular range of the grating. Thus, for a 3-micrometer thickness, a high P-polarization response may be achieved with a lower S-polarization response.

In many embodiments, the photonic crystal can be a reflective Bragg grating formed by an LC extraction process. A reflection Bragg grating made using phase separation followed by removal of the liquid crystal from the liquid crystal rich regions can enable wide angular and spectral bandwidth. The removal of the liquid crystal from the liquid crystal rich regions leaves air gaps between polymer regions. In many embodiments, replacing an input SBG with a reflection photonic crystal can be used to reduce the optical path from the PGU to the waveguide. In some embodiments, the PGU pupil and the waveguide can be in contact. In many embodiments, the reflection Bragg grating can be approximately 3 micrometers in thickness. The diffracting properties of an LC extracted Bragg grating may result from the refractive index difference between the polymer and air (not from the depth of the grating as is the case of a typical SRG).

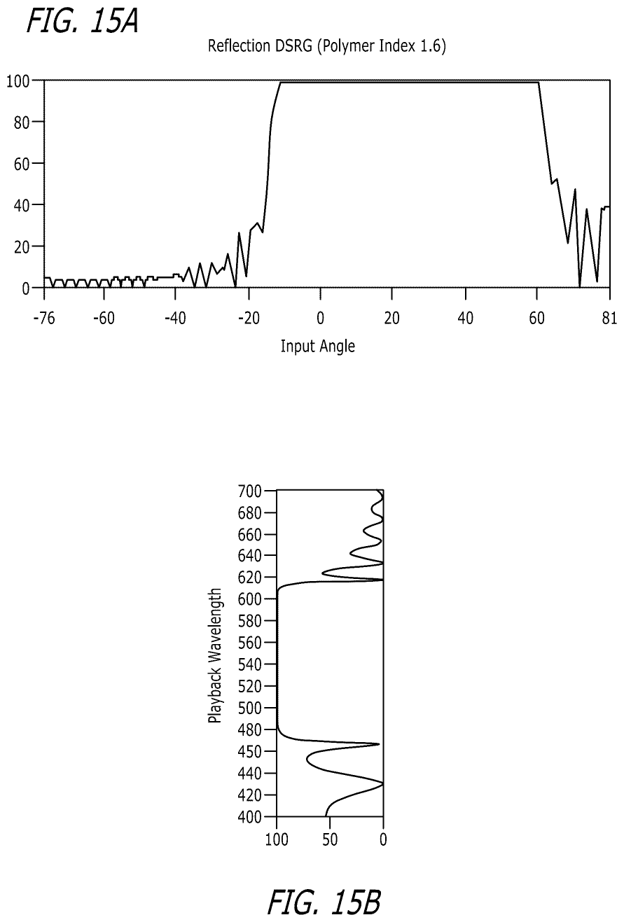

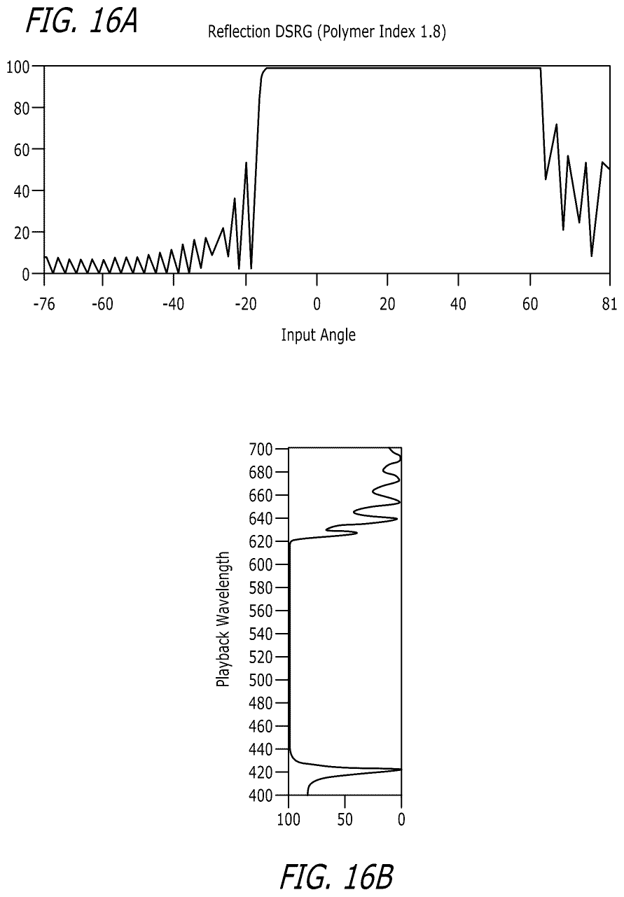

FIGS. 15A-15B show angular and spectral diffraction efficiency characteristics for a reflection structure formed from an HPDLC in accordance with an embodiment of the invention. The input and diffracted beam angles are 0° and 45° and the grating thickness is 3 micrometers. The refractive index of the polymer component of the grating may be 1.6 and the refractive index modulation (polymer/air) may be 0.3. The average index is obtained by taking the average of the refractive indices of the polymer and air ((1.6+1.0)/2=1.3). FIG. 15A shows the diffraction efficiency versus input angle in air. FIG. shows the diffractive efficiency versus wavelength. FIGS. 16A-16B show the corresponding diffraction efficiency characteristics of a grating formed from a polymer of index 1.8 (refractive index modulation 0.4) for the same beam angles. As shown, the higher index polymer results in an increase in the spectral bandwidth of the grating. The angular bandwidth (near 100%) covers all waveguiding angles. As illustrated in the diffraction efficiency plots, the spectral bandwidth of the grating covers most of visible band. By considering the diffraction efficiency obtained for S and P polarized light, it can be concluded that the DE characteristics do not vary significantly with polarization. Calculations also indicate that, in contrast to LC-extracted transmission gratings, neither the angular bandwidth nor the spectral bandwidth are affected by grating thickness.

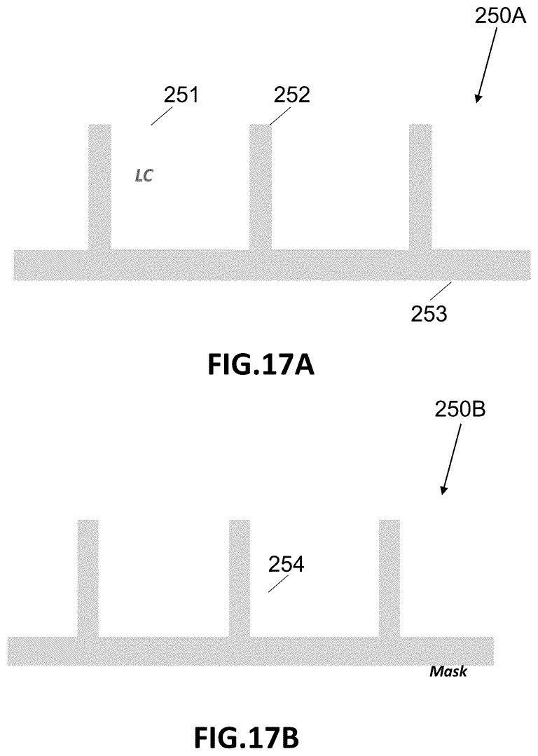

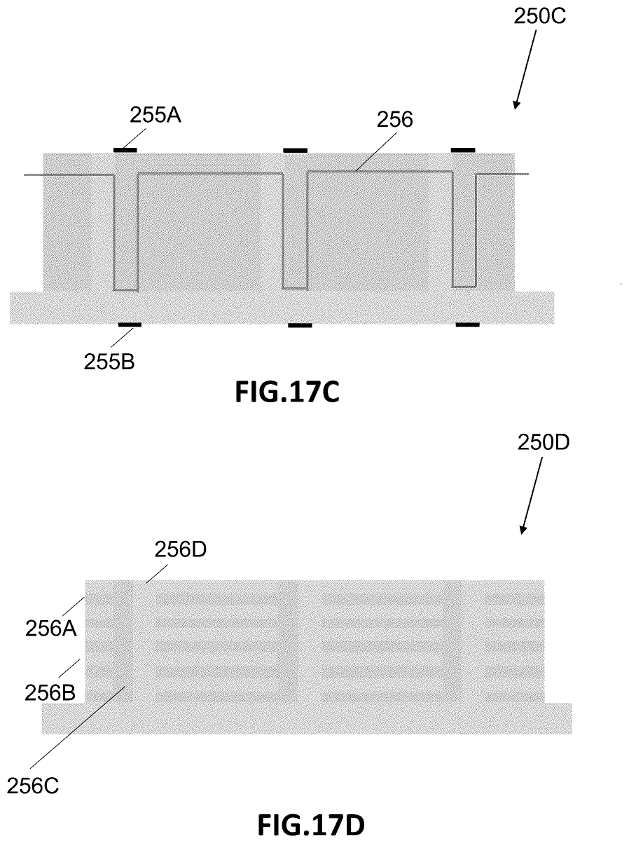

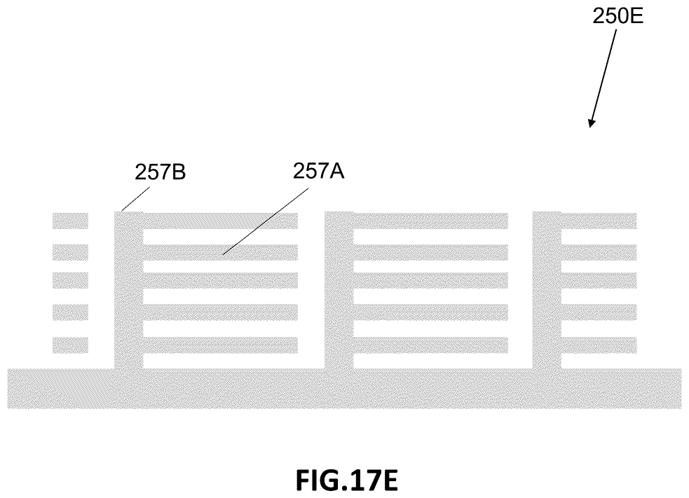

Reflective Bragg gratings with K-vectors substantially normal to the waveguide substrates may present problems in the removal of LC since the extraction may take place through the edges of the grating. Such a grating can also be structurally unstable due the polymer regions not being supported. In many embodiments, the reflection grating can be slanted to allow for LC extraction to take place through the upper and lower faces of the grating. In some embodiments with K-vectors substantially normal to the waveguide substrates, the reflective Bragg grating can incorporate polymer scaffolding. FIGS. 17A-17E illustrate the steps in fabricating a reflective Bragg grating in accordance with an embodiment of the invention. In a first step conceptually illustrated in FIG. 17A, a grating structure 250A having alternating LC 251 and polymer 252 regions supported by a substrate 253 is fabricated using a holographic exposure process as discussed above. Alternatively, a mask exposure process can be used. In a second step conceptually illustrated in FIG. 17B, the LC 251 is extracted to provide a surface relief grating structure 250B in which the LC regions are now air-filled regions 254. In a third step which is not illustrated, the grating 250B may be refilled with a material such as a liquid crystal and monomer mixture.

In a fourth step conceptually illustrated in FIG. 17C, a multiplexed grating combining a reflection grating (having K-vectors substantially normal to the substrate) and a transmission grating (having K-vectors substantially parallel to the plane of the substrate) may be recorded in the mixture in the grating 250C through upper 255A and lower 255B masks. The grating 250C is exposed from the top and the bottom with the upper mask 255A blocking light from the top and the lower mask 255B blocking light from the bottom. The exposure illumination modulated by the masks is indicated by 256. As can readily be appreciated, other arrangements of masks and illumination profiles can be used depending on the grating structures to be recorded.

In a fifth step, FIG. 17D conceptually illustrates an exposed grating 250D including alternating horizontally extending LC regions 256A and horizontally extending polymer regions 256B. The exposed grating 250D may also include vertically extending LC regions 256C adjacent to vertically extending polymer regions 256D. The vertically extending polymer regions 256D may provide scaffolding for the horizontally extending polymer regions 256B. In a final step conceptually illustrated in FIG. 17E, the LC is flushed out of the grating structure to form the finished grating 250E, which includes horizontally extending polymer gratings 257A and vertically extending polymer gratings 257B polymer grating elements that have principal optical surfaces in contact with air. In many embodiments, the finished grating 250E may be a reflection grating and can have a thickness in the range 1-3 micrometers.

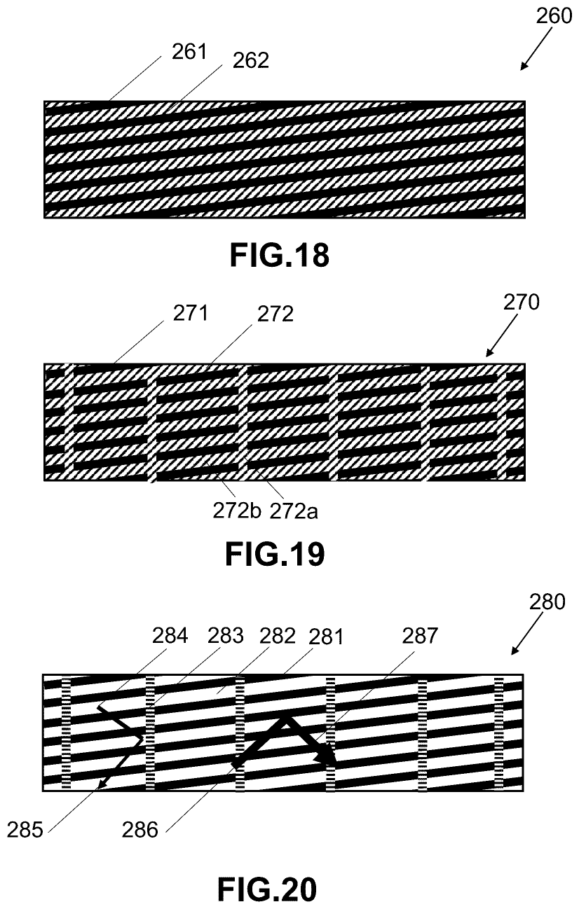

FIG. 18 conceptually illustrates a reflection grating 260 having alternate layers of a first refractive index material 261 and a second refractive index material 262 in accordance with an embodiment of the invention. The first refractive index material 261 and the second refractive index material 262 may be of different refractive index.

FIG. 19 conceptually illustrates a reflection grating 270 having alternate regions of a first refractive index material 271 and a second refractive index material 272 in accordance with an embodiment of the invention. The grating 270 also includes vertically extending regions 272a of the second refractive index material 272 which connect to multiple adjacent horizontally extending regions 272b.

FIG. 20 conceptually illustrates ray propagation in a combined transmission/reflection grating 280 having alternate regions of a first refractive index material 281 and a second refractive index material 282 and substantially vertically extending regions of a third refractive index material 283 in accordance with an embodiment of the invention. The first refractive index material 281 and the second refractive index material 282 alternate and extend at an oblique angle from the vertically extending regions of the third refractive index material 283. The combined transmission/reflection grating 280 includes a transmission grating and a reflection grating. The two gratings may operate over different angular ranges or in some embodiments over different wavelength ranges (for example one of the gratings could operate in the visible band while the other could operate in the infrared band). The two gratings material should have fringe spacings and index modulations to avoid crosstalk between the two gratings.

In some embodiments, the combined transmission/reflection grating 280 may be fabricated starting with the reflective grating 270 of FIG. 19 by removing vertically extending regions 272a of the second refractive material 272 and introducing the third refractive index material 283 into the removed vertical regions. Diffraction of light by the transmission grating may be formed by the average of the first refractive index material 281, the second refractive index material 282, and the third refractive index material 283 is represented by transmitted rays 284, 285. Diffraction of light by the refection grating formed by the first refractive index material 281 and the second refractive index material 282 is represented by reflected rays 286, 287.

In some embodiments, the combined transmission/reflection grating 280 may be a multiplexed transmission grating and reflection grating. The multiplexed transmission grating and reflection grating may be fabricated using a recoding mixture which may include materials which preferentially diffuse into the reflective fringes and the horizontal transmission fringes. The materials may have differing properties (e.g. diffusion coefficients, index and other parameters) resulting in the two gratings having different modulations.

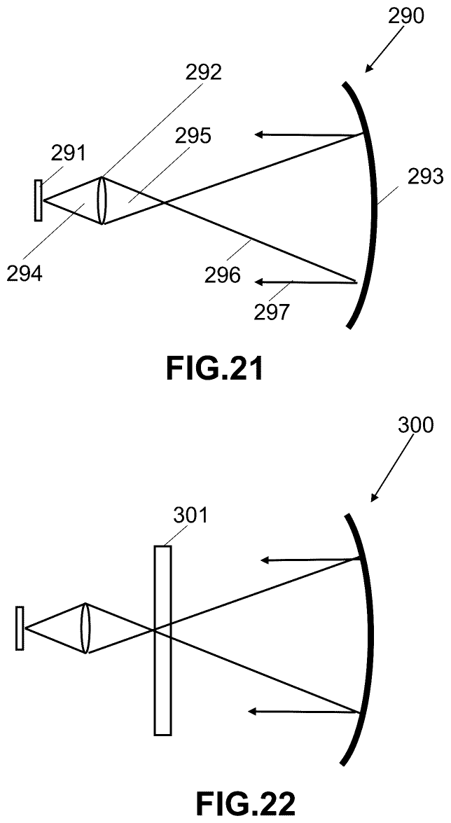

Photonic crystals and gratings as described above can be incorporated in structures for different applications in accordance with various embodiments of the invention. Many embodiments are directed towards waveguide displays, including but not limited to automotive HUDs and near eye displays. FIG. 21 conceptually illustrates a mirror illumination apparatus 290 for use in a waveguide display in accordance with an embodiment of the invention. The apparatus may include a microdisplay 291, a lens 292, and a curved mirror 293 for collimating the light. The light paths are illustrated by the rays 294-297. The rays 297 represent the collimated light to be coupled into the waveguide. FIG. 22 conceptually illustrates a mirror illumination apparatus 300 based on the apparatus of FIG. 21 which further includes a screen 301 disposed at the second focal plane of the lens in accordance with an embodiment of the invention. In many embodiments, the screen has light diffusing properties for controlling beam expansion. In many embodiments, the screen can be used to control numerical aperture (NA). In some embodiments, the screen can provide a spatially varying NA. In some embodiments, the screen can assist in controlling banding and other illumination nonuniformities resulting from beam propagation in the waveguide. In many embodiments, the NA can be optimized to reduce the total optics volume of the waveguide display. In some embodiments, the screen can be vibrated for the purposes of reducing laser speckle. In some embodiments, the screen has a curvature matching the focal surface of the mirror. In many embodiments, the screen is one selected from the group of a diffractive optical element, a multi-order diffractive optical element, an element having at least one Fresnel optical surface, and/or diffractive Fresnel element.

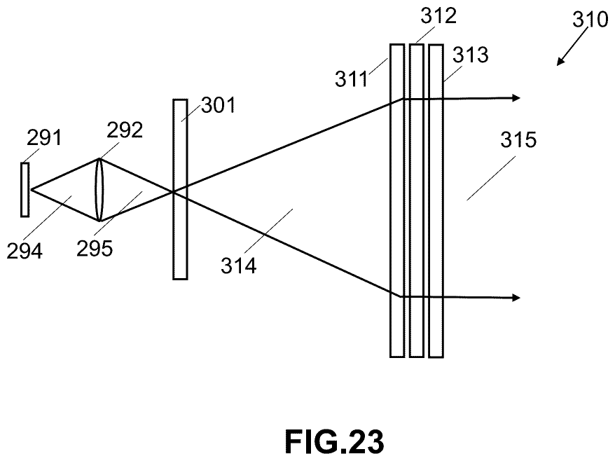

FIG. 23 conceptually illustrates an embodiment based on the embodiment of FIG. 22 in which the mirror 293 is replaced by stacked RGB diffracting gratings 311-313. As shown, the beam 314 may be collimated by the gratings 311-313 to provide the collimated output beam 315 which may be coupled into a waveguide. In some embodiments, input grating dispersion can be precompensated for in the PGU for each of RGB. In some embodiments, the grating stack 311-313 can provide a switching RGB correction element. In some embodiments, the grating stack 311-313 can include passive gratings. In some embodiments, passive gratings can be optimized to balance dispersion in the green band allowing residual blue and green dispersions. In some embodiments, the passive grating elements could be one selected from the group of a diffractive optical element, a multi-order diffractive optical element, an element having at least one Fresnel optical surface, and/or diffractive Fresnel element. In some embodiments, a dispersion correcting diffractive element with high diffraction efficiency (to eliminate the risk of high levels of zero order light entering the illumination path) can be disposed within the PGU. Dispersion correction using the waveguide input grating does not require high diffraction efficiency as zero order is naturally filtered out of the waveguide propagation paths.

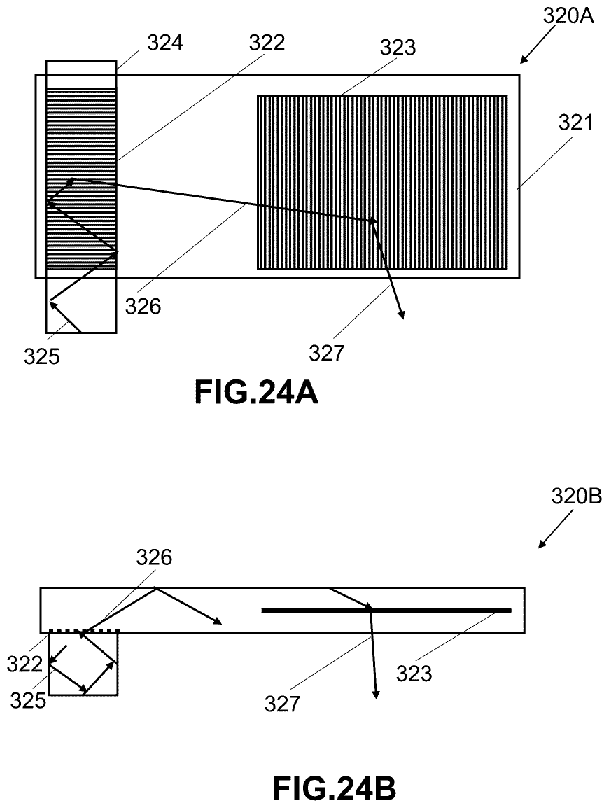

FIGS. 24A-24B conceptually illustrate various views of a waveguide apparatus including a light pipe in accordance with an embodiment of the invention. The apparatus 320A includes a waveguide 321 supporting an input grating 322, an output grating 323, and a light pipe 324. The light paths are illustrated by rays 325-327. As shown in the cross sectional view 320B in FIG. 24B, the light rays 325 in the light pipe 324 follow a spiral trajectory. In many embodiments, the light pipe 324 can provide an efficient refractive input coupler. Advantageously, the waveguide footprint may be determined by two gratings, compared to the three gratings as in other waveguide apparatuses including an input grating, a fold grating, and an output grating. In some embodiments, a plurality of waveguides may be stacked to display different colors. In some embodiments, the plurality of waveguides may include waveguides each displaying red, green, and/or blue light. The light pipes 324 for each of the waveguides may be offset with respect to each other.

Since the light pipe 324 provides first direction beam expansion, the K-vectors providing single axis expansion in a direction orthogonal to the first direction using the output grating are easier to manage. Light pipe architectures may present some challenges. Photonic crystals can offer potential for overcoming or reducing some of the following problems. A first one is the field of view may be limited. Another problem is that reverse paths in the input light path can generate double images. Another problem is that geometrical optical constraints required to control the spiral rotation direction may limit the pupil size, which means that banding suppression can be difficult to implement. Geometrical optical distortion can arise from the geometrical mismatch between input vertical face and the horizontal output surface. Efficient coupling into the non-spiral region of the waveguide can be challenging in many embodiments. Alignment of multiple or offset light guide paths can present a challenge in the design of the PGU.

One of ordinary skill in the art would have recognized that the various concepts discussed in connection with FIGS. 1-24 are applicable to the waveguide displays including heads-up displays discussed below.

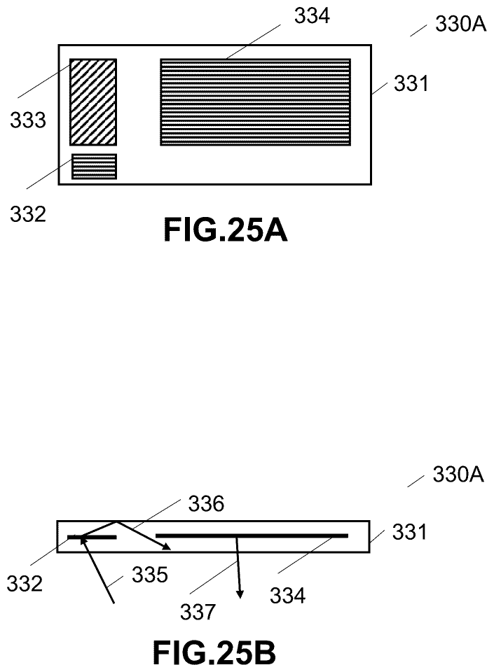

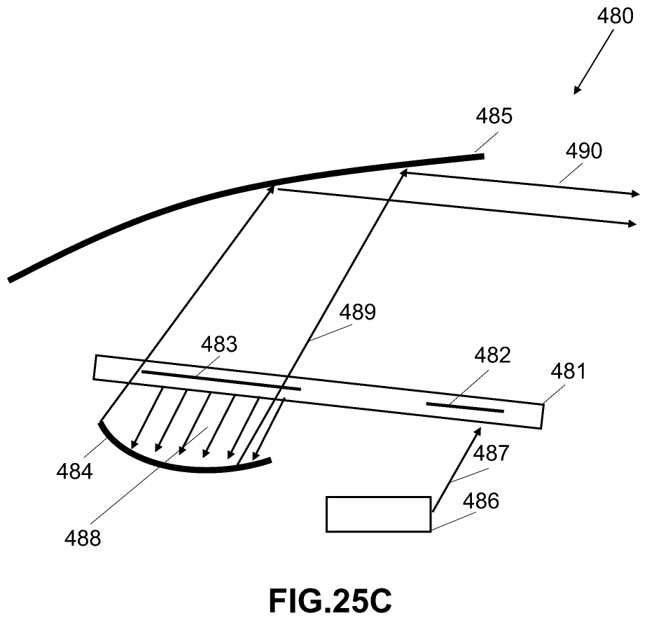

FIG. 25A conceptually illustrates an example waveguide arrangement in accordance with an embodiment of the invention. The waveguide can be stackable with other waveguides using a common PGU. The apparatus 330A includes a waveguide 331 supporting an input grating 332, a fold grating 333, and an output grating 334. FIG. 25B shows a cross section view of the waveguide of FIG. 25A, illustrating ray paths 335-337. The basic architecture can incorporate grating prescriptions providing 2D windshield correction functions and correction functions for compensating for chromatic aberrations and distortions contributed by the input image projection optics. Advantageously, the vertical field of view may be smaller for efficient coupling into the waveguide. In many embodiments, the K-vector of the output grating may be aligned such that extracted light has polarization matched to the windshield S-polarized reflection. Since the embodiment provides two axis waveguide expansion, a more compact and simpler PGU can be used. Any of the gratings (e.g. the input grating 332, the fold grating 333, and the output grating 334) can be implemented as photonic crystals.

FIG. 25C illustrates a design for a waveguide display implementing a mirror in accordance with an embodiment of the invention. This approach can be used with either 1D or 2D expansion architectures. The waveguide display 480 may be a heads-up display integrated into an automobile. The waveguide display 480 may include a waveguide 481 supporting an input grating 482 and an output grating 483. A mirror 484 may be positioned on an opposite side of the waveguide 481 from a reflection surface 485. The reflection surface 485 may be a surface of a windscreen. The mirror 484 may be a curved mirror for providing compensation for aberrations introduced by the reflection surface 485. The mirror 484 may be disposed overlapping the output grating to receive light extracted from the waveguide 481. The apparatus 480 may further include a PGU 486. Ray paths from the PGU to a viewing pupil or eyebox (not shown) are represented by rays 487-490. As illustrated, image containing light 487 may be output from the PGU 486 towards the waveguide 481. The light may be input into the waveguide 481 into total internal reflection (TIR) through the input grating 482. The output grating 483 may be used to extract the light 488 from the waveguide 481 towards the mirror. The mirror 484 may reflect the light 488 into reflected light 489 towards the reflection surface 485 which may reflect the light 489 into light 490 reflected towards a viewer. In the illustrated embodiment, there is no prescription power in the output grating 483 for windshield compensation.

In some embodiments, the mirror 484 can be a Fresnel element. As illustrated, the mirror 484 may be a curved mirror. The mirror 481 may have polarization characteristics for compensating at least one of polarization rotation introduced by beam propagation in the waveguide and polarization rotation introduced by reflection at the reflection surface 485 to provide a predefined polarization of light viewed through the eyebox.

In many embodiments, the output grating 483 may not have prescription power. Eliminating the prescription power from the output grating 483 may greatly simplify the design of the output grating 483 and ensure that the waveguided light can maintain a high degree of collimation ensuring high diffraction efficiency and avoidance of brightness nonuniformities in the final image. The mirror 484 can have a range of prescriptions for correcting aberrations and distortions, which may include Seidel monochromatic aberrations, higher order monochromatic aberrations, and distortions. The mirror surface of the mirror 484 may be aspheric. In some embodiments, the mirror surface of the mirror 484 may include a freeform surface. In some embodiments, the mirror 484 may combine a negative meniscus lens with the surface on the rear side of the glass coated to form a curved mirror (a Mangin mirror).

In some embodiments, the mirror 484 may be diffractive mirror. In many embodiments, the mirror 484 may be a diffractive mirror which may be a reflection hologram formed on a flat surface. In some embodiments the reflection hologram may be formed on a curved surface to enable better control of optical aberrations. In some embodiments, the reflection hologram may include separated layers each being sensitive to a specific wavelength band, for example red, green, and blue. In some embodiments, a reflection holographic mirror may include red, green, and/or blue switchable holograms configured to be switched into their diffracting states color sequentially with red, green, and/or blue information to be displayed being provided color sequentially by the PGU 486.

In many embodiments, the apparatus of FIG. 25C may further include polarization modifying layers (not shown) disposed between the output grating 483 and the mirror 484. In many embodiments, an air gap may be provided between the mirror 484 and the waveguide 481. In many embodiments, one or more optical filters may be disposed between the output grating 483 and the mirror 484 to fine tune the spectral characterizes of the image light. In many embodiments, other components such as one or more filters (including louver arrays) for blocking stray light from the waveguide 481 or blocking sunlight may be disposed between the output grating 483 and the mirror 484. In some embodiments, to maximize compatibility between different windscreens and to minimize production costs, the mirror 484 may include an optical prescription including a universal base curvature and a windscreen-dependent prescription. In some embodiments where the mirror 484 is a holographic mirror including a hologram substrate curvature, the universal base curvatures may be provided by a hologram substrate curvature and the windshield dependent prescription may be provided by an optical prescription provided by the holographic substrate curvature. In some embodiments, the mirror 484 may be implemented using a portion of the waveguide 481. In many embodiments, the mirror 484 may support coatings for rotating the polarization of image light. In many embodiment, at least one of input grating 482 and/or the output grating 483 in the waveguide 481 may have an optical prescription for compensating for aberrations and distortions introduced by the mirror 484.

In some embodiments, the mirror 484 may include an array of reflective elements. In many embodiments, the mirror 484 may include an array of elements configured to perform light field imaging. In many embodiments, the mirror 484 may include an array of elements that refract and reflect light. In many embodiments, the mirror 484 may include an array of diffractive optical elements. In many embodiments, the mirror 484 may be mechanically or thermally deformable to provide variations in optical power. In many embodiments, the mirror 484 may capable of tilting to adjust the eyebox location.

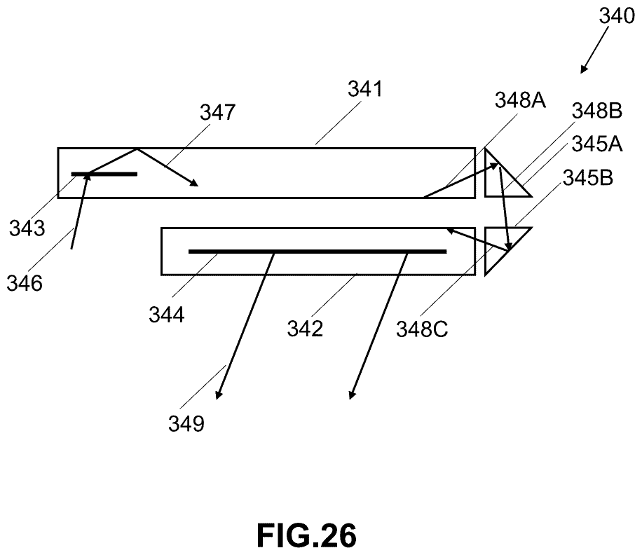

FIG. 26 conceptually illustrates a folded waveguide arrangement for reducing the overall grating footprint in accordance with an embodiment of the invention. The folded waveguide 340 includes a first waveguide 341 overlapping a second waveguide 342. The first waveguide 341 contains an input grating 343. The second waveguide 342 supports an output grating 344. The waveguides are optically connected by two prisms 345A, 345B such that the prisms direct light from one end of the first waveguide 341 into the second waveguide 342. The ray paths are represented by rays 346-349. Any of the gratings can be photonic crystals. The folded waveguide 340 may be integrated as the waveguide 481 of FIG. 25C.

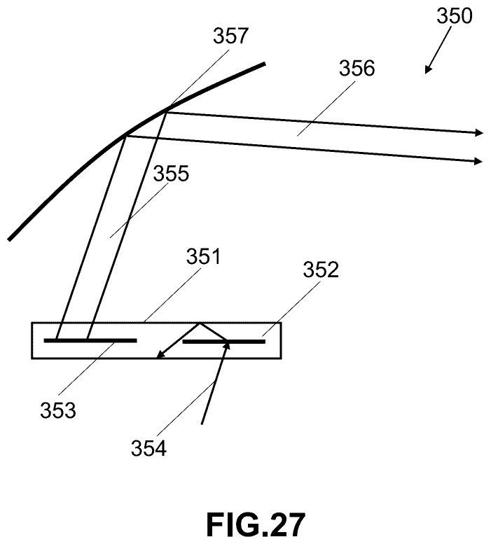

FIG. 27 conceptually illustrates a waveguide display using a deep SRG input grating according to the principles discussed above in accordance with an embodiment of the invention. The waveguide display 350 includes a waveguide 351 supporting an input grating 352 and an output grating 353. The ray paths are represented by rays 354-356. The output rays 355 from the waveguide 351 are reflected off a reflective surface 357 such as a windscreen towards an eyebox of a viewer.

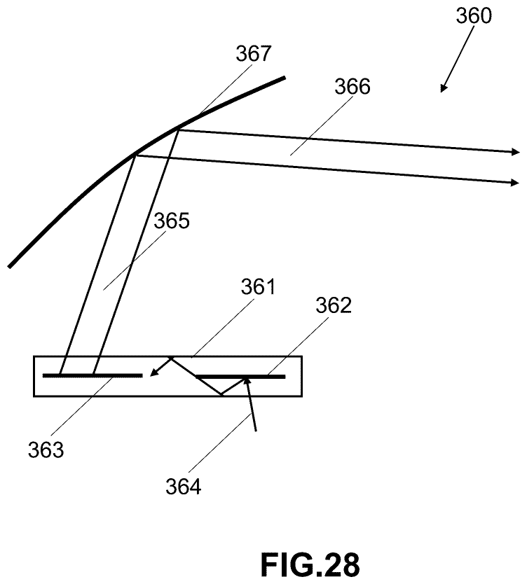

FIG. 28 conceptually illustrates a waveguide display using a reflective photonic crystal input grating in accordance with the principles discussed above and in accordance with an embodiment of the invention. The waveguide display 360 includes a waveguide 361 supporting an input grating 362 and an output grating 363. The ray paths are represented by rays 364-366. The output rays 365 from the waveguide 361 are reflected off a reflective surface 367 such as a windscreen towards an eyebox of a viewer. As illustrated, the input grating 362 may be a reflective photonic crystal input grating which inputs light into TIR in the waveguide 361 through reflection. This is different from the input grating 352 of FIG. 27 which is a deep SRG input grating which inputs light into TIR in the waveguide 352 via transmission.

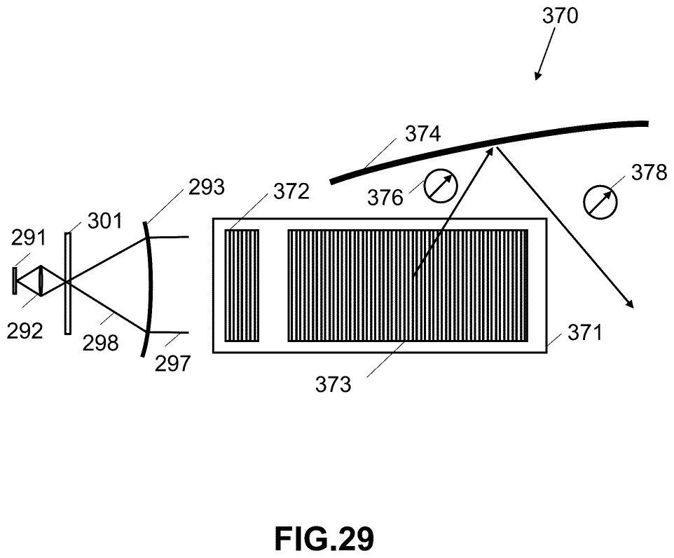

FIG. 29 schematically illustrates a waveguide display including a horizontal single axis expansion architecture 370 in accordance with an embodiment of the invention. The waveguide display shares many identically numbered features as FIGS. 21-23. The description of these features is applicable to FIG. 29 and will not be repeated in detail. The waveguide display 370 includes a waveguide 371 supporting an input grating 372 and an output grating 373. A polarization state of the extracted light is indicated by the symbol 376 and a polarization state of light reflected from a reflective surface 374 such as a windscreen is indicated by the symbol 378. In many embodiments, the polarization of light extracted from the waveguide 371 and incident on the reflective surface 374 can be aligned with the polarization state for light reflected off the reflective surface 374 towards an eyebox of a viewer.

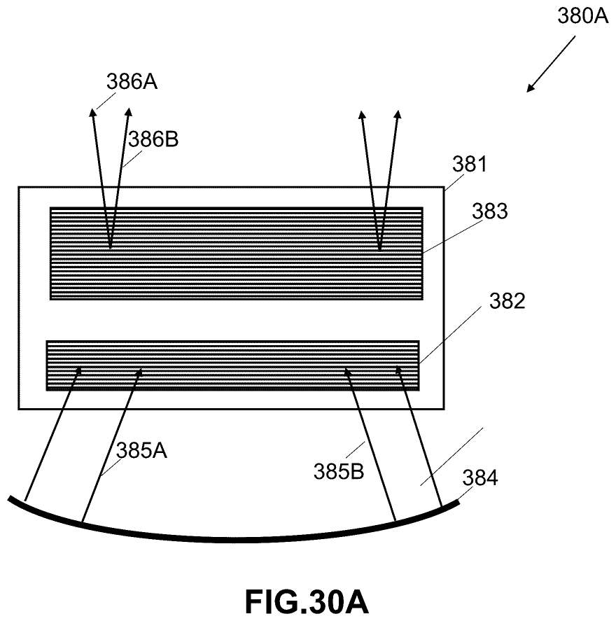

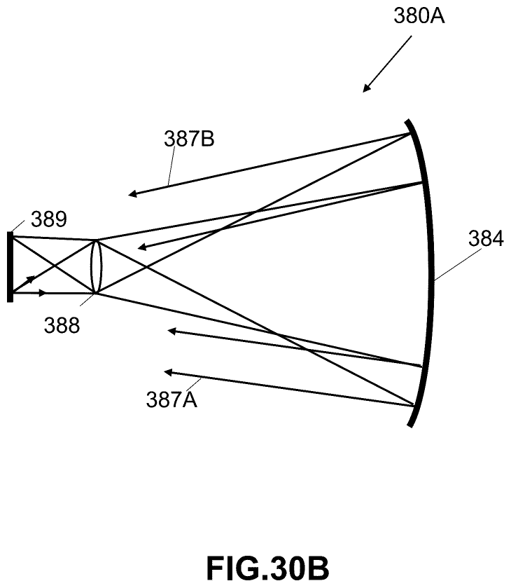

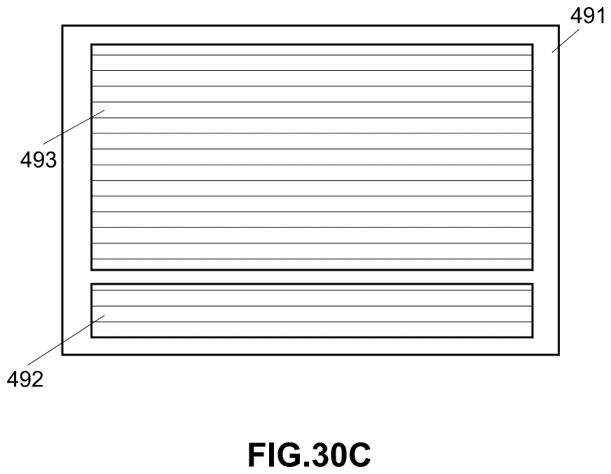

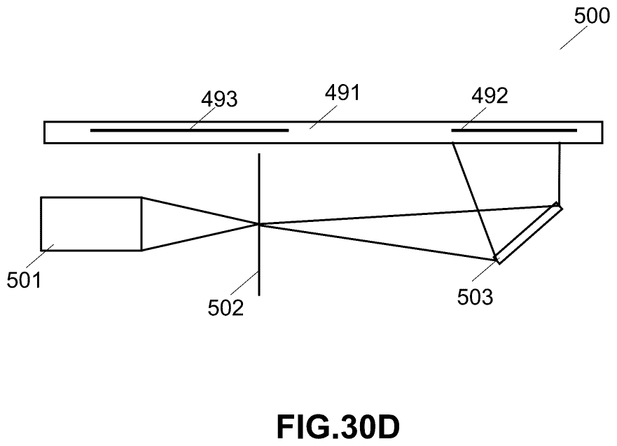

FIGS. 30A-30B illustrate a schematic of a waveguide display 380A with no fold grating in accordance with an embodiment of the invention. The waveguide display 380A includes a waveguide 381 supporting an input grating 382 and an output grating 383. The waveguide display 380A further includes a mirror 384 for collection and collimation of light projected from a screen 389 by a lens 388. In some embodiments, a half wave film can be applied to the extraction surface of the waveguide 381 to align the output polarization with the preferred reflection polarization of the windscreen. In many embodiments, the waveguide display 380A can incorporate a multi order diffractive optical element for holographic aberration correction. In many embodiments, the width of the waveguide is approximately 140 mm. In many embodiments, the waveguide display 380A provides one dimensional expansion which may be easier to design and implement and elimination of the fold grating reduces the width of the waveguide. The optical propagation distance may be shorter, improving contrast. The use of the screen 389 may shorten the projector length.

FIGS. 30C-30D illustrates a modified version of the waveguide display described in connection with FIGS. 30A-30B in accordance with an embodiment of the invention. The waveguide display 500 has an input grating 492 with a collimating mirror incorporated in the input grating 492. The waveguide display 500 includes a waveguide 491 supporting an input grating 492 and an output grating 493. The waveguide display 500 further includes a PGU 501, a screen 502, and a mirror 503. The input grating 492 can include corrective power to collimate light from the PGU 501. In many embodiments, the waveguide display can include a reflective multi order diffractive optical element to precompensate for dispersion.

In many embodiments, the PGU 501 may be a short throw projector including waveguide integrated laser display (WILD) which can be used for removing speckle, including speckle introduced by the screen. A description of WILD including the many components which make a projector including WILD are discussed in U.S. patent Ser. No. 10/670,876, entitled “Waveguide laser illuminator incorporating a despeckler” and filed on Feb. 8, 2017 which is hereby incorporated by reference in its entirety for all purposes. In some embodiments, a waveguide despeckler (not shown) may be positioned along the optical path from the PGU 501 to the input grating 492 of the waveguide 491. In some embodiments, a mechanically displaceable screen may be positioned along the optical path from the PGU 501 to the input grating 492 of the waveguide 491. The mechanically displaceable screen may function as a despeckler (to remove speckle). The screen may form part of the waveguide despeckler. In many embodiments, zero order light not diffracted by a multi-order diffractive optical element (MODOE) can be trapped to avoid degrading the image. Advantageously, the MODOE may have high diffraction efficiency. In some instances, a curved mirror under the input grating 492 may cause zero order light incident on the input grating 492 to cause haze or ghost images. Advantages of the embodiment of FIGS. 30C-30D may include easier hat one-dimensional expansion. The MODOE may correct dispersion for each of R, G, and B independently. This may allow collimation optics to be incorporated in the waveguided input grating. In many embodiments, the MODOE for dispersion compensation can be disposed inside the PGU 501.

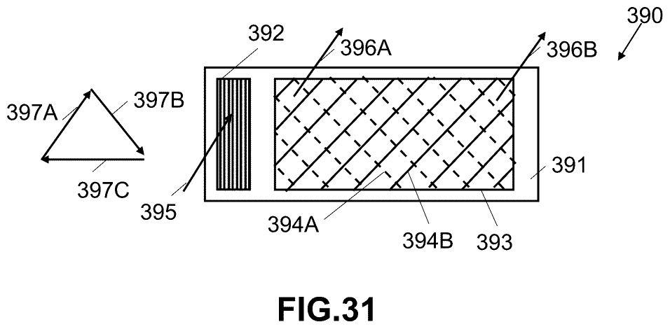

FIG. 31 conceptually illustrates a waveguide display including an integrated dual axis (IDA) architecture in accordance with an embodiment of the invention. IDA is described in U.S. Pat. App. Pub. No. 2020/0264378 entitled “Methods and Apparatuses for Providing a Holographic Waveguide Display Using Integrated Gratings” and filed Feb. 18, 2020 which is hereby incorporated by reference in its entirety for all purposes. The waveguide display 390 includes a waveguide 391 supporting an input grating 392 and crossed fold gratings 394A, 394B. The input light and extracted light are represented by the rays 395 and 396A, 396B. The K-vectors of the three gratings are represented by 397A-397C. The input grating can be a photonic crystal.

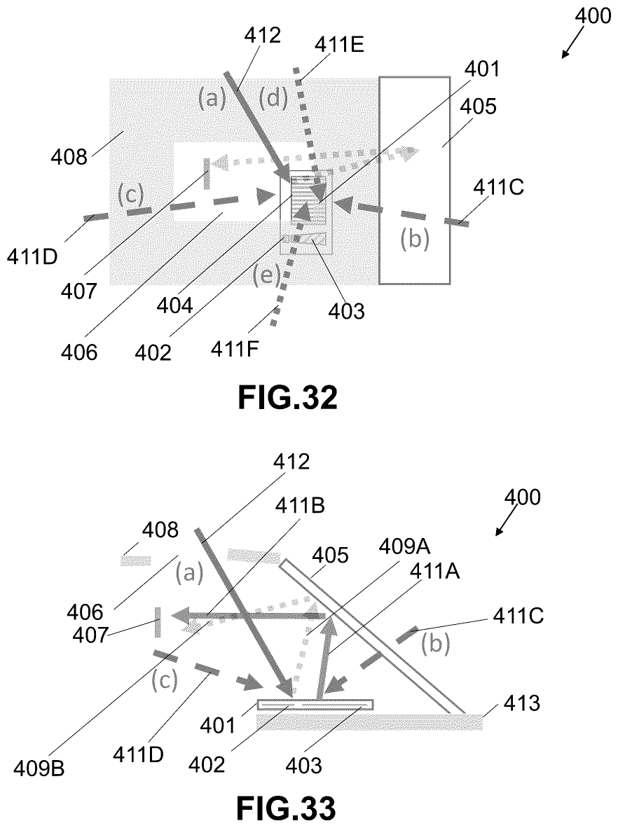

FIGS. 32-33 conceptually illustrate various views of heads up display 400 with a waveguide illustrating potential unwanted sunlight in accordance with an embodiment of the invention. The waveguide 401 supporting an input grating 402, a fold grating 403, and an output grating 404. The waveguide 401 may be integrated into a waveguide display for heads up display applications. The heads up display 400 may include a windscreen 405, and a viewer eyebox 407. A sunroof 408 containing an aperture 406 for sunlight entry are also illustrated. The image light diffracted out of the waveguide towards the windscreen is indicated by the ray 411A. The image light reflected off the windscreen towards eyebox is indicated by the ray 411B. Examples of possible unwanted sunlight paths include and are labeled with their corresponding letters from (a)-(e):
(a) Sunlight entering the cabin of the vehicle in which the heads up display is installed directly overhead along the path 412 from the rear at 0-45 degrees to the vertical via the aperture 406 of the sunroof 408 may be reflected off the waveguide 401. The light may be further reflected off the windscreen 405 towards the eyebox 407 via the paths 409A, 409B.
(b) Sunlight entering the cabin along path 411C through the windshield 405 may diffract directly off waveguide 401 into the eyebox 407 (path to eyebox not shown).
(c) Sunlight entering the cabin along path 411D through the rear windshield (not shown) may reflect off the waveguide 401 and off the windshield 405 towards the eye box 407 (path to eyebox not shown).
(d) Sunlight entering the cabin from the left along paths 411E via the aperture 406 via may be diffracted into the eyebox 407 via the waveguide 401 (path to eyebox not shown).
(e) Sunlight entering the cabin from the right along paths 411F via the aperture 406 may be diffracted into the eyebox 407 by the waveguide 401 (path to eyebox not shown)

Overhead paths via the aperture 406 of sunroof 408 to left (d) and right (e) may be unlikely to get reflected or diffracted into the eyebox 407. Sunlight in such paths is more likely to may get diffracted into a direction away from the eyebox 407. Similarly, light entering the cabin via the side windows of the cabin may be more likely to get diffracted or reflected away from the eyebox 407 and thus may not be consequential. The most significant contribution of unwanted sunlight may come from (a). In some embodiments, an optical sunlight rejection layer discussed below may be used to suppress unwanted sunlight from the described optical paths.

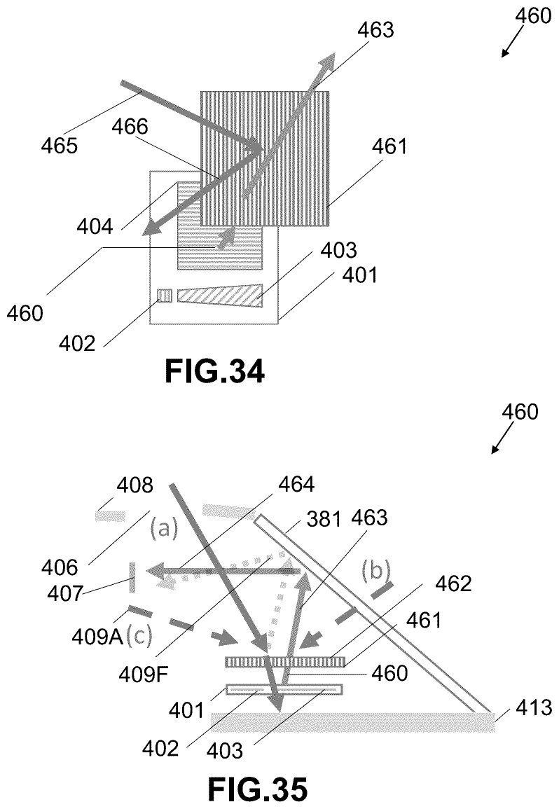

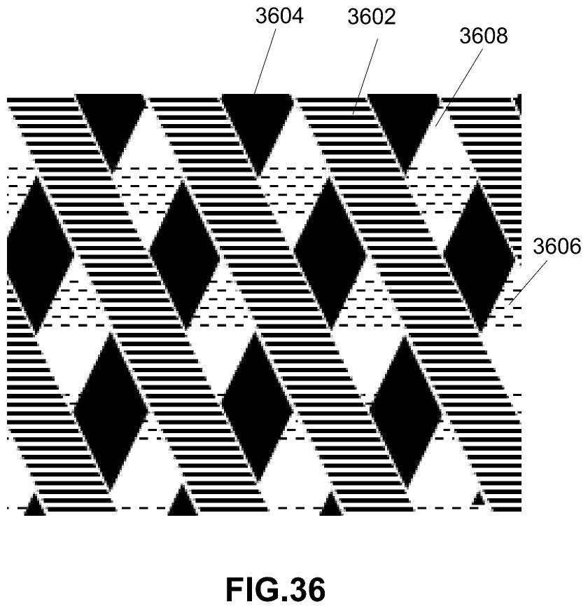

FIGS. 34-35 schematically illustrate various views of heads up display 460 with a waveguide 401 integrating a sunlight blocking grating 461 in accordance with an embodiment of the invention. The heads up display 460 includes many identically labeled components as the heads up display 400 of FIGS. 32-33. The description of these components is applicable to the heads up display 460 and will not be repeated in detail. In many embodiments, an AR coating 462 can be applied to the upper surface of the sunlight blocking grating 461. The sunlight 465 to be blocked may be mainly overhead and behind the driver. The sunlight blocking grating 461 may be a switchable Bragg grating (SBG) with spatially varying K-vectors and clock angles for directing sunlight into directions 466 away from directions that would otherwise be diffracted or windshield-reflected into the eyebox 407. The sunlight blocking grating 461 may include a substrate supporting a switchable Bragg grating layer disposed in proximity to a reflecting surface of the waveguide 401. The switchable Bragg grating may have a spatially varying k-vector and clock angle for directing sunlight away from directions that would otherwise be diffracted or reflected into the eyebox.

The SBG may include a spatially varying k-vector and clock angle for directing sunlight away from directions that would otherwise be diffracted or windshield-reflected into the eyebox 407. The sunlight blocking grating 461 may have a large angular bandwidth. The sunlight blocking grating 461 can also be configured so that that the HUD light is off-Bragg with respect to the sunlight blocking grating 461 or is transmitted through the sunlight blocking grating 461 without substantial modification of the HUD light polarization, which must be matched to the reflection polarization of the windscreen. In some embodiments where the sunlight blocking grating may affect the polarization of the HUD light, compensatory rotation of the HUD polarization may be provided by the waveguide gratings or by the PGU. For example, light 460 from the waveguide 401 may exit the sunlight blocking grating 461 as polarized light 463 with polarization matched to the reflection polarization of the windscreen.

In many embodiments, a photonic crystal formed by liquid crystal extraction be used for form a multiplexed grating. FIG. 36 shows a multi-grating structure in accordance with an embodiment of the invention. In a first step, a first mixture of liquid crystal is provided. A first grating 3602 having alternating liquid crystal and polymer regions can be formed in the first mixture using a holographic exposure. The LC regions can be flushed to form a first set of polymer regions separated by air. The grating formed from flushing the LC regions flushed may be referred to as an evacuated Bragg grating (EBG). A second mixture of liquid crystal can be provided in the air regions of the first grating 3602. A second grating 3604 having alternating liquid crystal and polymer regions can be formed in the second mixture using a holographic exposure. The LC regions can be flushed to form polymer regions separated by air. A third mixture of liquid crystal can be provided in the air regions formed by the first grating 3602 and second grating 3604. A third grating 3606 having alternating liquid crystal and polymer regions can be formed in the second mixture using a holographic exposure. The LC regions can be flushed to form polymer regions separated by air. Examples of gratings formed through holographic exposure of a liquid crystal and monomer mixture and subsequent flushing of the LC regions to create an EBG are disclosed in U.S. Pat. App. Pub. No. 2021/0063634 entitled “Evacuating Bragg gratings and methods of manufacturing” and filed on Aug. 28, 2020 which is hereby incorporated by reference in its entirety for all purposes.

FIG. 36 shows the final grating structure formed by the above process. The first grating 3602, second grating 3604, and third grating 3606 are overlapping. In many embodiments, the three superimposed gratings 3602, 3604, 3606 may have the same refractive index. The white triangular areas represent the air spaces 3608 remaining after the above process has been completed. The structure of FIG. 36 multiplexes the three gratings 3602, 3604, 3606. In some embodiments, the three gratings 3602, 3604, 3606 may be formed from different monomers to provide a required spatial refractive index modulation variation. In some embodiments, the air regions 3608 can be backfilled with an optical material for providing a desired refractive index contrast. A skilled artisan would understand that a similar process can be applied to multiplexing any number of grating structures subject to material and process limitations.

One important advantage of the LC EBGs is that they may not clear at elevated temperature which may be advantageous for automotive use, or any other higher temperature environment use. The EBGs may be applied to gratings of any scale.

In some embodiments, the resultant superimposed grating has spatially varying diffraction efficiency. In some embodiments, the resultant superimposed grating may include multiplexing and/or spatial varying thickness, k-vector directions, and/or diffraction efficiency.

In some embodiments, the gratings 3602,3604,3606 may be recorded in uniform modulation liquid crystal-polymer material system such as the ones disclosed in U.S. Pat. App. Pub. No. US 2007/0019152 entitled “Holographic diffraction grating, process for its preparation and opto-electronic devices incorporating it” and filed May 26, 2006 and U.S. Pat. App. Pub. No. PCT App. No. 2008/0063808, entitled “Method for the Preparation of High-Efficient, Tuneable and Switchable Optical Elements Based on Polymer-Liquid Crystal Composites” and filed Oct. 1, 2007, both of which are incorporated herein by reference in their entireties for all purposes. Uniform modulation gratings are characterized by high refractive index modulation (and hence high diffraction efficiency) and low scatter.

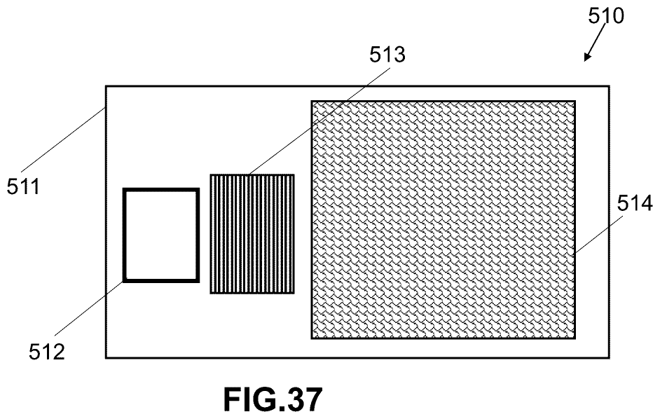

FIG. 37 conceptually illustrates a waveguide display 510 including an integrated dual axis (IDA) architecture in accordance with an embodiment of the invention. Various IDA architectures are disclosed in U.S. Pat. App. Pub. No. 2020/0264378 entitled “Methods and Apparatuses for Providing a Holographic Waveguide Display Using Integrated Gratings” and filed Feb. 18, 2020 which is hereby incorporated by reference in its entirety for all purposes. The waveguide display 510 includes the waveguide 511 supporting an input grating 512, a further grating 513, and grating structure 514 formed from crossed fold gratings. As discussed in the above references, in many embodiments the crossed fold gratings can be multiplexed or formed from separate overlapping fold grating layers. The further grating 513 may be a transmission SBG which may be switchable into a diffractive state 513A and non-diffractive state 513B to produce multiple fields of view.

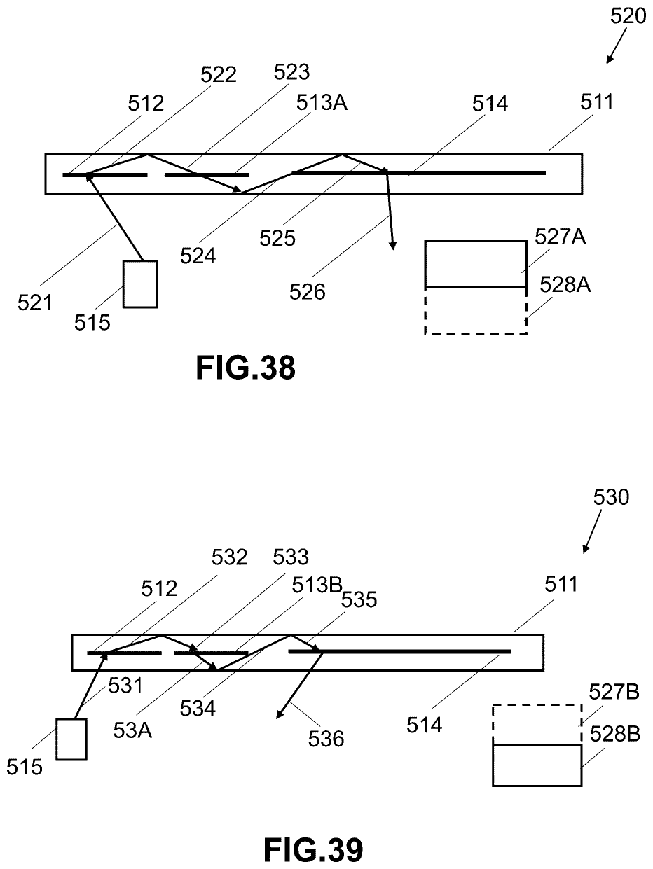

FIGS. 38-39 schematically illustrate a cross sectional view of the waveguide display 510 of FIG. 37 illustrating two example operational states. In FIG. 38, the input light from a picture generation module 515 which displays an image for display in an upper field of view portion 527A is represented by the rays 521 which is coupled into the waveguide by the reflection grating 512. The light may be transmitted through the further grating 513 which is in a non-diffracting operational state 513A while the upper field of view portion image is projected. The TIR path in the waveguide is represented by the rays 522-525. The light is extracted from the waveguide into the ray direction 526 which corresponds to a point in an upper field of view portion 527A which is filled with the image content projected from the picture generation module 515. The upper field of portion abuts a blank lower field of view portion 528A.

In FIG. 39, the input light from a picture generation module 515 which displays an image for display in the lower field of view portion 527B is represented by the rays 531 which is coupled into the waveguide by the reflection grating 512. The light may be transmitted through the further grating 513 which is in a diffracting operational state 513B while the lower field of view portion image is projected. In its diffracting state, the further grating 513 imparts a beam deflection to the guided light. The TIR path in the waveguide is represented by the rays 532-535. The light is extracted from the waveguide into the ray direction 536 which corresponds to a point in the lower field of view portion 528B which is filled with the image content projected from the picture generation module. The lower field of portion abuts a blank upper field of view portion 527B.

The input grating 512 and the further grating 513 can be configured in different ways to facilitate the formation of the two abutting (or tiled) field of view regions. In many embodiments, the input grating 512 and further grating 513 can at least partially overlap. In many embodiments, the input grating 512 can be a transmission grating and the further grating 513 can be a reflection grating. In many embodiments, either the input grating 512 or the further grating 513 can be switchable gratings such as SBGs. In many embodiments, both gratings can be switchable gratings. In general, a reflection grating has the advantage of a large angular bandwidth than a transmission grating. It should be apparent from consideration of the above description and the drawings that the same principle can be applied to the formation of tiled field of view displays in which two or more field of view regions can be tiled together horizontally or vertically.

In other embodiments, picture generation module 513 may include an external switching mechanism to present the two field of view portions at offset angles relative to each other. In such embodiments, a non-switching input grating can be used to couple light into the waveguide. A second non-switching grating can be used to adjust the guide light angles prior to interaction with the output grating which may be a crossed grating structure.

The disclosures of the applications and patents below are herein incorporated by reference in their entireties: US patent Application No. U.S. Ser. No. 13/506,389 entitled COMPACT EDGE ILLUMINATED DIFFRACTIVE DISPLAY, U.S. Pat. No. 8,233,204 entitled OPTICAL DISPLAYS, PCT Application No.: PCT/US2006/043938 entitled METHOD AND APPARATUS FOR PROVIDING A TRANSPARENT DISPLAY, PCT Application No. PCT/GB2012/000677 entitled WEARABLE DATA DISPLAY, United States patent Application No.: U.S. Ser. No. 13/317,468 entitled COMPACT EDGE ILLUMINATED EYEGLASS DISPLAY, United States Patent Application No.: U.S. Ser. No. 13/869,866 entitled HOLOGRAPHIC WIDE ANGLE DISPLAY, United States Patent Application No.: U.S. Ser. No. 13/844,456 entitled TRANSPARENT WAVEGUIDE DISPLAY, PCT Application No.: PCT/GB2012/000680 entitled IMPROVEMENTS TO HOLOGRAPHIC POLYMER DISPERSED LIQUID CRYSTAL MATERIALS AND DEVICES, U.S. Ser. No. 16/242,979 entitled Waveguide Architectures and Related Methods of Manufacturing, U.S. application Ser. No. 15/558,409 entitled Waveguide device incorporating a light pipe, U.S. Provisional Application No. 62/893,715 entitled Methods and Apparatus for Providing a Waveguide Display Using an Emissive Input Image Panel, U.S. Provisional Application No. 62/839,493 entitled Holographic Waveguide Illumination Homogenizer, U.S. Provisional Application No. 62/858,928 entitled Single Grating Layer Color Holographic Waveguide Displays and Related Methods of Manufacturing, U.S. Provisional Application No. 62/808,970 entitled Holographic Polymer Dispersed Liquid Crystal Mixtures with High Diffraction Efficiency and Low Haze, U.S. Provisional application Ser. No. 62/778,239 entitled Single Layer Color Waveguide, U.S. Provisional Application No. 62/663,864 entitled Process for fabricating grating using inkjet printing process, U.S. application Ser. No. 16/007,932 entitled Holographic Material Systems and Waveguides Incorporating Low Functionality Monomers, and U.S. Application No. 62/923,338, entitle Photonic Crystals Formed in HPDLC and Methods for Fabricating the Same.

### Doctrine of Equivalents

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A heads-up display comprising:
a picture generation unit for projecting collimated light over a field of view;
a first waveguide comprising an input grating for coupling the light from the picture generation unit into a total internal reflection path in the first waveguide and an output grating for providing beam expansion and light extraction from the first waveguide;
a curved transparent substrate; and
a mirror disposed with its reflecting surface facing a waveguide output surface of the first waveguide,
wherein the mirror is configured to reflect light extracted from the first waveguide back through the first waveguide towards the curved transparent substrate,
wherein the first waveguide is configured such that the curved transparent substrate reflects light extracted from the first waveguide towards an eyebox forming a virtual image viewable through the transparent curved substrate from the eyebox.

2. The heads-up display of claim 1, wherein the curved transparent substrate is a windshield.

3. The heads-up display of claim 1, wherein the light reflected from the mirror through the waveguide is off-Bragg with respect to the output grating.

4. The heads-up display of claim 1, wherein the first waveguide further comprises a fold grating, wherein the fold grating is configured to provide a first beam expansion and the output grating is configured to provide a second beam expansion orthogonal to the first beam expansion.

5. The heads-up display of claim 1, wherein the output grating provides a dual axis expansion grating configuration.

6. The heads-up display of claim 1, wherein the mirror has a surface curvature for compensating the aberrations produced by the curved transparent substrate.

7. The heads-up display of claim 1, wherein the mirror has polarization characteristics for compensating at least one of polarization rotation introduced by beam propagation in the waveguide and polarization rotation introduce by reflection at the substrate to provide a predefined polarization of light viewed through the eyebox.

8. The heads-up display of claim 1, wherein the mirror has a Fresnel form.

9. The heads-up display of claim 1, wherein the input grating and/or the output grating comprises at least one selected from the group consisting of: a non-switchable grating, a switchable Bragg grating, a grating recorded in a mixture of liquid crystal and polymer, a surface relief grating, a deep surface relief grating, a deep grating formed by extracting liquid crystal from a grating recorded in a mixture of liquid crystal and polymer, a photonic crystal, a reflection grating, and a transmissive grating.

10. The heads-up display of claim 1, wherein the picture generation unit comprises a light source, a microdisplay panel, and a projection lens.

11. The heads-up display of claim 1, wherein the picture generation unit comprises a laser scanner.

12. The heads-up display of claim 1, wherein the picture generation unit comprises a screen and a collimator, wherein the screen forms an intermediate projected image.

13. The heads-up display of claim 12, wherein the screen is one selected from the group consisting of: a diffractive optical element, a multi-order diffractive optical element, a Fresnel optical surface, a diffractive Fresnel element, a substrate with spatially varying diffusion properties matched to numerical aperture of the collimator, a screen formed on a substrate with a curvature matching the focal surface of the collimator, and a screen formed on a substrate that can be vibrated to reduce speckle.

14. The heads-up display of claim 12, wherein the collimator is one selected from the group consisting of: a lens, a mirror, and a stack of diffractive optical elements operating at different wavelengths or configured to provide a first beam expansion orthogonal to a second beam expansion provided by the output grating.

15. The heads-up display of claim 1, further comprising a second waveguide,
wherein the picture generation unit comprises a light source configured to emit a first wavelength light and a second wavelength light,
wherein the first wavelength light is coupled into the first waveguide and the second wavelength light is coupled into the second waveguide, and
wherein the first waveguide and the second waveguide form a stack.

16. The heads-up display of claim 1, further comprising a halfwave film applied to a light extraction surface of the first waveguide.

17. The heads-up display of claim 1, further comprising a waveguide despeckler positioned along the optical path from the picture generation unit to the input grating of the waveguide.

18. The heads-up display of claim 1, further comprising a mechanically displaceable screen positioned along the optical path from the picture generation unit to the input grating of the waveguide.

19. The heads-up display of claim 1, further comprising a substrate supporting a switchable Bragg grating layer disposed in proximity to a reflecting surface of the waveguide, wherein the switchable Bragg grating has a spatially varying k-vector and clock angle for directing sunlight away from directions that would otherwise be diffracted or reflected into the eyebox.

20. The heads-up display of claim 19, wherein the switchable Bragg grating is at least one of configured to off-Bragg to light extracted from the waveguide or configured to have a preferred polarization different than that of light extracted from the waveguide.

21. The heads-up display of claim 1, wherein the mirror is a curved mirror.

22. The heads-up display of claim 1, wherein the first waveguide comprises an input waveguide containing the input coupler and an output waveguide containing the output grating, wherein the input waveguide and the output waveguide are positioned substantially overlapping, and wherein light from the input waveguide is coupled into the output waveguide through a plurality of prisms.

23. The heads-up display of claim 1, wherein a mirror surface of the mirror is aspheric.

24. The heads-up display of claim 1, wherein the mirror comprises a negative meniscus lens with a surface on the rear side of a glass coated to form a curved mirror.

25. The heads-up display of claim 1, wherein the mirror comprises a diffractive mirror.

26. The heads-up display of claim 25, wherein the diffractive mirror comprises a reflective hologram formed on a flat surface.

27. The heads-up display of claim 25, wherein the diffractive mirror comprises a reflective hologram formed on a curved surface.

28. The heads-up display of claim 25, wherein the diffractive mirror comprises a reflective hologram made of separated layers each being sensitive to a specific wavelength band.

29. The heads-up display of claim 1, further comprising polarization modifying layers disposed between the output grating and the mirror.

30. The heads-up display of claim 1, wherein an air gap is disposed between the mirror and the output grating.

31. The heads-up display of claim 1, further comprising one or more optical filters disposed between the output grating and the mirror.

32. The heads-up display of claim 31, wherein the one or more optical filters fine tune the spectral characteristics of the light extracted from the first waveguide.

33. The heads-up display of claim 1, further comprising one or more filters disposed between the mirror and the output grating.

34. The heads-up display of claim 33, wherein the one or more filters block stray light from the first waveguide or block sunlight.

35. The heads-up display of claim 33, wherein the one or more filters comprise louver arrays.

36. The heads-up display of claim 1, wherein the mirror includes an optical prescription including a universal base curvature.

37. The heads-up display of claim 36, wherein the optical prescription is dependent upon the curvature of the curved transparent substrate.

38. The heads-up display of claim 37, wherein the mirror comprises a holographic mirror including a hologram substrate curvature and wherein the optical prescription is provided by the hologram substrate curvature.

39. The heads-up display of claim 1, wherein the mirror is a portion of the first waveguide.

40. The heads-up display of claim 1, wherein the mirror includes coatings for rotating the polarization of the extracted light.

41. The heads-up display of claim 1, wherein the input grating and/or the output grating include an optical prescription for compensating for aberrations and distortions introduced by the mirror.

42. The heads-up display of claim 1, wherein the mirror comprises an array of reflective elements.

43. The heads-up display of claim 1, wherein the mirror comprises an array of elements configured to perform light field imaging.

44. The heads-up display of claim 1, wherein the mirror comprises an array of diffractive optical elements.

45. The heads-up display of claim 1, wherein the mirror is mechanically and/or thermally deformable to provide variations of optical power.

46. The heads-up display of claim 1, wherein the mirror is configured to tilt to adjust for various eyebox locations.

47. A method of fabricating a device comprising the steps of:
providing a picture generation unit, a waveguide comprising an input coupler and an output grating, a curved transparent substrate, and a mirror;
coupling light into a waveguide;
extracting light from the waveguide;
using the mirror to reflect light through the waveguide onto the curved substate, wherein the light incident on the curved transparent substrate is reflected towards an eyebox of a viewer.

48. The method of claim 47, wherein the mirror has a surface curvature for compensating the aberrations produced by the curved transparent substrate.

49. The method of claim 47, wherein the mirror has polarization characteristics for compensating at least one of polarization rotation introduced by beam propagation in the waveguide and polarization rotation introduce by reflection at the curved transparent substrate to provide a predefined polarization of light viewed through the eyebox.

50. The method of claim 47, wherein the mirror has a Fresnel form.
